(19) United States
(12) Patent Application Publication
(10) Pub. No.: US 2022/0122171 A1
(43) Pub. Date: Apr. 21, 2022

(54) CLIENT SERVER SYSTEM FOR FINANCIAL SCORING WITH CASH TRANSACTIONS

(71) Applicant: Happy Money, Inc., Tustin, CA (US)

(72) Inventors: Jason Hubard, Tustin, CA (US); Chris Courtney, Tustin, CA (US); Michael Tepper, Tustin, CA (US); Andrea Trivella, Tustin, CA (US); Alison Tan, Tustin, CA (US); Meng Zhao, Tustin, CA (US); Chong Geng, Tustin, CA (US); Turgut Ozkan, Tustin, CA (US); Tara Bleakley, Tustin, CA (US); Rita Stanger, Tustin, CA (US); David Blair, Tustin, CA (US); R Scott Saunders, III, Tustin, CA (US); Dan Sinner, Tustin, CA (US); Adam Zarlengo, Tustin, CA (US); Ibrahim Dusi, Tustin, CA (US)

(73) Assignee: Happy Money, Inc., Tustin, CA (US)

(21) Appl. No.: 17/503,257

(22) Filed: Oct. 15, 2021

Related U.S. Application Data
(60) Provisional application No. 63/092,504, filed on Oct. 15, 2020.
(60) Provisional application No. 63/093,155, filed on Oct. 16, 2020.
(60) Provisional application No. 63/093,162, filed on Oct. 16, 2020.
(60) Provisional application No. 63/093,169, filed on Oct. 17, 2020.
(60) Provisional application No. 63/093,172, filed on Oct. 17, 2020.

(51) Int. Cl. G06Q 40/02; G06Q 10/06; G06Q 20/10

(52) U.S. Cl. CPC G06Q 40/025; G06Q 20/102; G06Q 10/06393

(57) ABSTRACT

In accordance with one embodiment, a method includes receiving a loan application from a debtor with unsecured debt; receiving financial transactions data associated with the debtor; parsing the financial transactions data into predetermined data features; verifying the income of the debtor on the loan application with the parsed financial transactions data; ranking the parsed financial transactions data based on the predetermined data features; and analyzing the parsed financial transactions data to determine a first probability of default by the debtor with a loan having a lower interest rate than an interest rate of the unsecured debt. The loan application includes income, payments/expenses, assets, and liabilities/debt to determine a stated net income for verification with a calculated net income. The income verification provides the calculated net income for comparison with the stated net income and a measure of reliability of the input data in the loan application. The income verification can set up one or more cutoff levels for loan origination processing. The financial transactions data includes one or more bank/savings accounts, one or more income sources, one or more debts/liabilities, and one or more expense sources. The method can further include receiving credit bureau data from at least one credit bureau associated with the debtor; removing and discarding a FICO score from the credit report; and analyzing the trade lines data of the credit report to determine a second probability of default by the debtor with the loan. The credit bureau data comprises a credit report with trades lines data.

### CROSS REFERENCE

This patent application claims priority to U.S. Provisional Patent Application No. 63/092,504, titled CLIENT SERVER SYSTEM FOR FINANCIAL SCORING WITH TRANSACTIONS filed Oct. 15, 2020 by R. Scott Saunders III et al., and is incorporated herein by reference for all intents and purposes. This patent application further claims priority to U.S. Provisional Patent Application No. 63/093,155, titled CLIENT SERVER SYSTEM FOR CREDIT SCORING WITH CASH TRANSACTIONS DATA filed Oct. 16, 2020 by R. Scott Saunders III et al., and is incorporated herein by reference for all intents and purposes. This patent application further claims priority to U.S. Provisional Patent Application No. 63/093,162, titled CLIENT SERVER SYSTEM FOR CLOUD LENDING SOLUTIONS filed Oct. 16, 2020 by R. Scott Saunders III et al., and is incorporated herein by reference for all intents and purposes. This patent application further claims priority to U.S. Provisional Patent Application No. 63/093,169, titled CLIENT SERVER SYSTEM FOR ACTIVE LENDING INTELLIGENCE filed Oct. 17, 2020 by R. Scott Saunders III et al., and is incorporated herein by reference for all intents and purposes. This patent application further claims priority to U.S. Provisional Patent Application No. 63/093,172, titled LENDING SYSTEM WITH ACTIVE INTELLIGENCE filed Oct. 17, 2020 by R. Scott Saunders III et al., and is incorporated herein by reference for all intents and purposes.

### FIELD

The embodiments relate generally to financial planning, predicting credit risk, loan consolidation, and loan origination.

### BACKGROUND

Credit scores are widely used by lenders because they are inexpensive and largely accepted by consumers and lenders. However, they do have a number of drawbacks. For example, studies have shown that the FICO (Fair Isaac Corporation) score is not always a good predictor of credit risk. Studies have also shown that the accuracy of FICO score in predicting delinquency has diminished in recent years. The FICO score is blind to income, cash flow, account balances, savings, and investments. The FICO scoring process is slow to respond to a job loss. In addition, there are ways for a consumer to game the FICO scoring system so that it is not an accurate measure of loan delinquency. Generally, credit bureau data is becoming increasingly less trustworthy. Therefore, improved techniques for predicting credit risk of an individual are desirable to speed decision making, reduce the risk of loan defaults and loan delinquency, assure the individual has the capability of making cash payments towards a loan while maintaining a certain lifestyle, and provide more loans to credit worthy individuals that are often overlooked with traditional FICO scores.

Additionally, individuals often do not perform any budgeting of expenses to balance against their income. Accordingly, individuals often spend more for goods and services than the amount that they receive in their income. It is desirable to provide basic online financial planning for users to balance expenses versus income, to provide online savings plans to afford future purchases, and manage their cash flow to reduce their risk of loan defaults and loan delinquency for loans (debt), if any.

### BRIEF SUMMARY

The embodiments are summarized by the claims that follow below.

### BRIEF DESCRIPTIONS OF THE DRAWINGS

FIG. 1 is a block diagram of a client server system for determining transactional credit risk and matching debtors with lenders as part of a loan origination process to consolidate current unsecured debts with high interest rates down into a new unsecured loan with a lower interest rate.

FIG. 2 is a block diagram of financial technical services provided by the client server system between a borrower and lenders.

FIG. 3A is a block diagram of a loan origination engine.

FIG. 3B is a block diagram of the artificial intelligence modeling associated with the loan origination engine.

FIG. 4 is a functional block diagram of the loan origination process with financial scoring with transactions.

FIG. 5 is a functional block diagram of the cash transactions engine.

FIG. 6, comprising FIGS. 6A-6B, is a functional block diagram of the income verifier.

FIG. 7 is a functional block diagram of the credit bureau engine.

FIG. 8 is a chart of eight exemplary financial transaction features of interest indicating their strength of contributions (t-value) to a probability of default.

FIGS. 9A and 9B are example user interfaces of charts comparing cash transaction scores to charge-off rates.

FIGS. 10A and 10B are example user interfaces of charts illustrating checking account balance volatility and charge off rates for groups of borrower/applicants in the model.

FIGS. 11A and 11B are example user interfaces of charts illustrating population counts (y axis-chart) and charge off rates (y axis-chart) for grouped ranges of the number of overdrafts per borrower (x axis).

FIGS. 12A and 12B are example user interfaces of charts illustrating savings balance and charge off rates for groups of borrower/applicants in the model.

FIG. 13A-13B are example user interfaces of charts comparing default risk (e.g., charge-off risk) to a calculated number of income sources.

FIGS. 14A-14B are example user interfaces of charts illustrating the spending-to-income ratios (spending divided by income).

FIGS. 15A and 15B are user interfaces of charts illustrating the ratio of total cash balances divided by the monthly payment that would be made on a desired loan (loan amount and term).

FIGS. 16A and 16B are user interfaces of charts illustrating the number of borrowers associated with a range of income sources.

FIGS. 17A and 17B are user interfaces of charts illustrating the stability (or instability) of the primary paycheck amount associated with a borrower over two or more pay periods of time.

FIGS. 18A and 18B are user interfaces of charts illustrating the mean or average overdraft amount of the checking account associated with a borrower.

FIGS. 19A and 19B are user interfaces of charts illustrating a ratio of the mean or average credit card balance over (divided by) the average or mean monthly discretionary spending (credit card debt to discretionary spending or income) associated with a borrower.

FIG. 20 is a user interface of a chart illustrating plots of transaction score distributions (probability of default-X axis versus number of borrowers-Y axis) for six tiers of different borrowers.

FIG. 21 is a user interface of chart illustrating receiver operating characteristics (ROC) curves for measuring model performance.

FIG. 22 is a diagram illustrating how sets of borrower records in databases can be generated and used to train, verify, and test a machine learning model.

FIG. 23 is a diagram illustrating a logistic regression algorithm that can be used to model the probability of default based on a debt balance to income (BTI) ratio.

FIG. 24 is an example resultant user interface output to an applicant/borrower illustrating a plurality of adverse actions and failure advice that may be given.

FIGS. 25A-25C are charts and diagrams comparing a credit bureau score (FICO) with the happy money score.

FIG. 26 is a diagram illustrating advantages of calculating a happy personality, including a happy money score.

FIG. 27 is an example diagram illustrating a single branch of a classification model for a gradient boosted decision tree.

FIG. 28 is a diagram is to explain a SHAP value for a feature of a gradient boosted decision tree machine learning model.

FIGS. 29A-29B are charts indicating segmentation of borrowers into groups and tiers.

### DETAILED DESCRIPTION

In the following detailed description of the embodiments, numerous specific details are set forth in order to provide a thorough understanding. However, it will be obvious to one skilled in the art that the embodiments may be practiced without these specific details. In other instances, well known methods, procedures, and components have not been described in detail so as not to unnecessarily obscure aspects of the embodiments.

The embodiments include a method, apparatus and system for financial scoring with transactions to improve loan origination to more credit worthy borrowers. The financial scoring with transactions (financial transactions score) can include a cash transactions score and a credit score if available. The financial transactions score can be referred to herein as a happy money score (alternately referred to herein as the fused financial score or combination financial score). The financial transactions score is a financial metric designed to provide incremental visibility over standard credit scoring models (e.g., Fair Isaac Corporation—FICO score) into the creditworthiness of applicants for unsecured loan products. The model for financial scoring with transactions, evaluates consumer credit decisions and helps ensure compliance with applicable consumer protection regulations. The model predicts the likelihood of consumer charge-off on an unsecured loan product. In one embodiment, the model can generate normalized scores in a range from zero (0) to one (1). In another embodiment, the model can generate scores similar to those of the Fair Isaac Corporation (FICO) score, such as between 300 and 850. The higher scores, near one, represent higher credit risk or a greater probability that a borrower would default on a loan. Like traditional credit scores, the model for financial scoring with transactions complies with the United States Equal Credit Opportunity Act (ECOA); 15 United States Code § 1691 et seq.; by utilizing an empirically derived, demonstrably, and statistically sound credit scoring system without discriminating on the basis of race, color, religion, national origin, sex, marital status, or age.

### Computer Server System

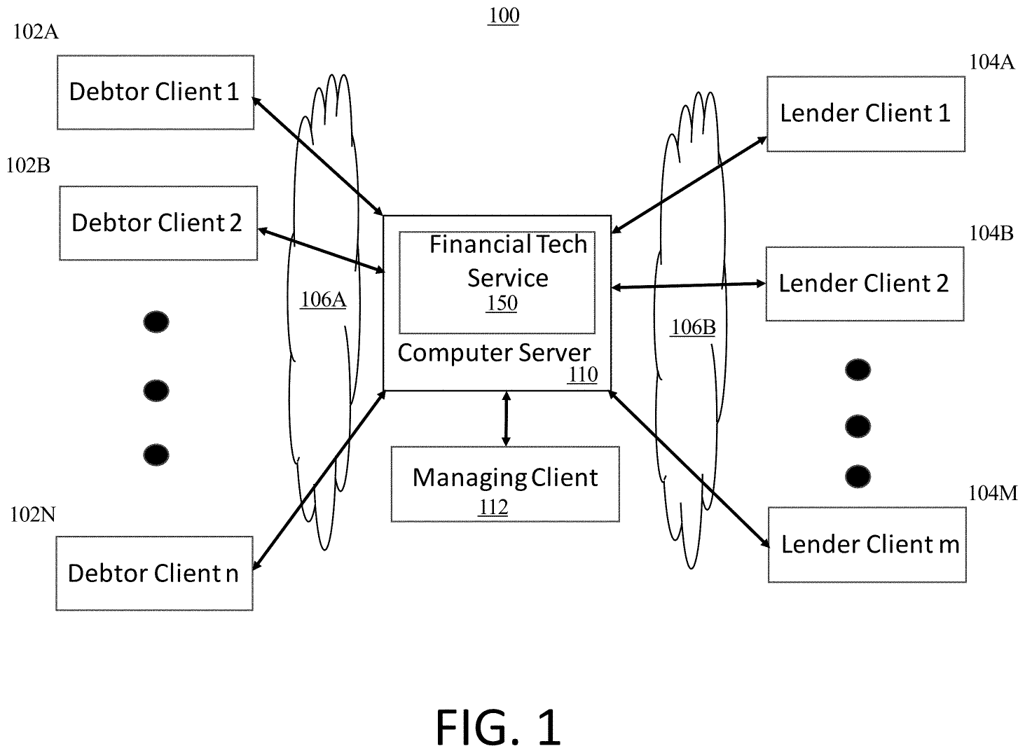

FIG. 1 illustrates a client server system 100 to provide financial technical services 150, such as loan origination. The system 100 can include N debtor clients (potential borrowers) 102A-102N (collectively 102), M lender clients 104A-104M (collectively 104), a computer server 110, and at least one managing client 112. The computer server 110 executes software to provide the financial technical services 150. The debtor clients 102 can communicate over an internet cloud 106A to the computer server 110. The lender clients 104 can communicate over an internet cloud 106B to the computer server 110. Components of the client-server system 100 are devices of computer hardware, software, or a combination thereof.

The managing client 112 is often local using a local area network to communicate with the computer server 110. In other cases, the managing client 112 is remote and can communicate using a wide area network, such as the internet or internet cloud 106A-106B, to communicate with the computer server 110.

The financial technical services 150 provided by the server 110 can match debtor (applicant/borrower) clients 102 with lender clients 104 in order to consolidate pre-existing debts into one loan with lower interest rates, for example. In accordance with one embodiment, the debtor clients 102 are consumers and the lender clients 104 are credit unions issuing loans business to consumers. In another embodiment, the debtor clients 102 are businesses and the lender clients 104 are banks issuing loans, business to business.

### Financial Tech Services

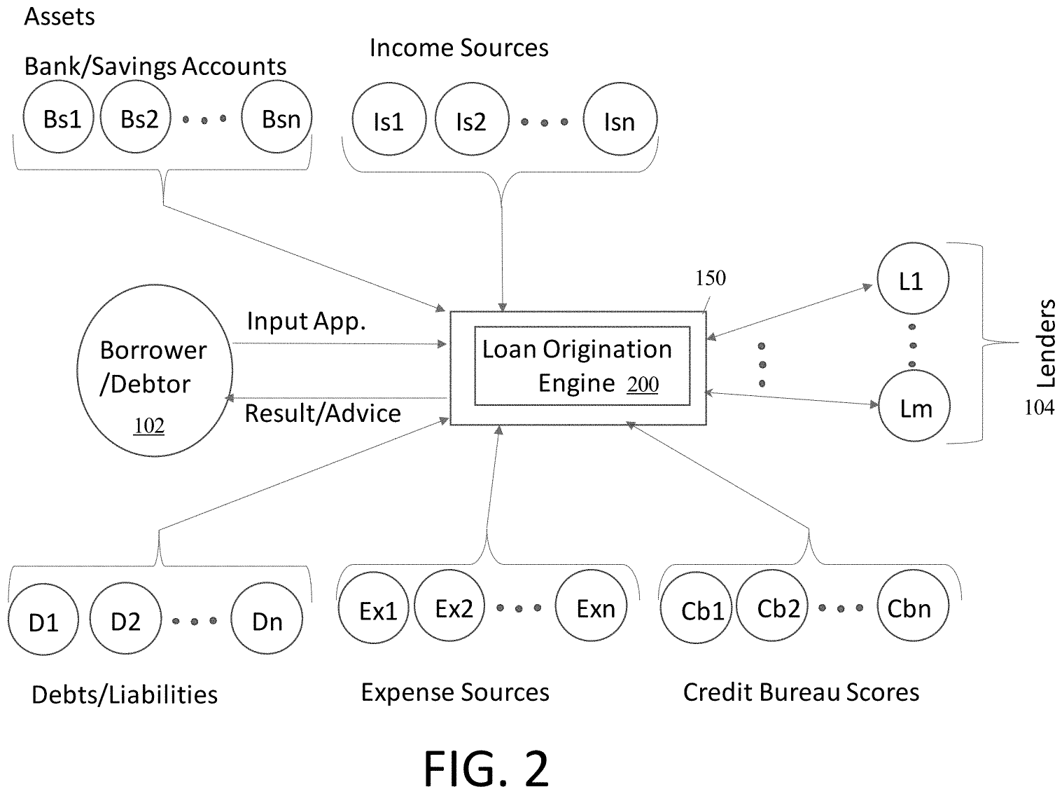

Referring now to FIG. 2, one of the financial tech services 150 that can be provided by the server is loan origination. Other financial tech services 150 can be provided by the server. The financial tech service 150 includes a loan origination engine 200 to facilitate loan origination between a plurality of debtor clients 102 and a plurality of lender clients 104. For each debtor client 102, the loan origination engine 200 tries to match up the debtor with at least one of a plurality of lenders L1-Lm 104 for a loan to consolidate unsecured debt, such as credit card debt, with a lower interest rate. The loan origination engine 200 utilizes the model that generates financial scoring with transactions, referred to herein as a happy money score (alternatively referred to herein as a transactional financial score), to provide improved visibility into the credit worthiness of a borrower over standard credit scoring models.

The loan origination engine 200 receives an input application from the borrower/debtor 102 indicating the debtor's monthly income and expenses as well as preexisting liabilities (debts) and assets (bank/savings accounts). The loan origination engine 200 is in communication with pre-existing lenders L1-Lm 104 to place loans with the debtors 102.

The debtor 102 authorizes the loan origination engine 200 to directly communicate with banks, creditors, employers, payors, payees and credit bureaus to verify the information provided in the input application. Accordingly, the loan origination engine 200 further receives information pertaining to none or more bank/savings accounts Bs1-Bsn; none or more income sources Is1-Isn, none or more debts/liabilities D1-Dn, and none or more expense sources Ex1-Exn, all collectively referred to herein as transactions data. The loan origination engine 200 further receives credit bureau scores/reports Cb1-Cbn.

The loan origination engine 200 verifies the information provided in the input application with the external sources of information (e.g., bank/savings accounts; debts/liabilities). If the information in the received input application for the given borrower is not verifiable or is substantially inaccurate (e.g., not within one or more thresholds of the value for income, expenses, debt and assets) a loan can be refused.

The borrower/debtor 102 receives the result/advice of processing the loan application he/she submitted. If the loan application is approved, the borrower is advised about his/her happy money score, the principal amount, the interest rate, and term of years. The loan application can be passed on (fast pass) as approved based on information verification, the borrower's risk variance being below a cutoff point based on lending tiers, the happy money score, and/or a use-of-loan model score. Alternatively, further borrower verification may be needed to clear issues in the borrower's financial history or scores.

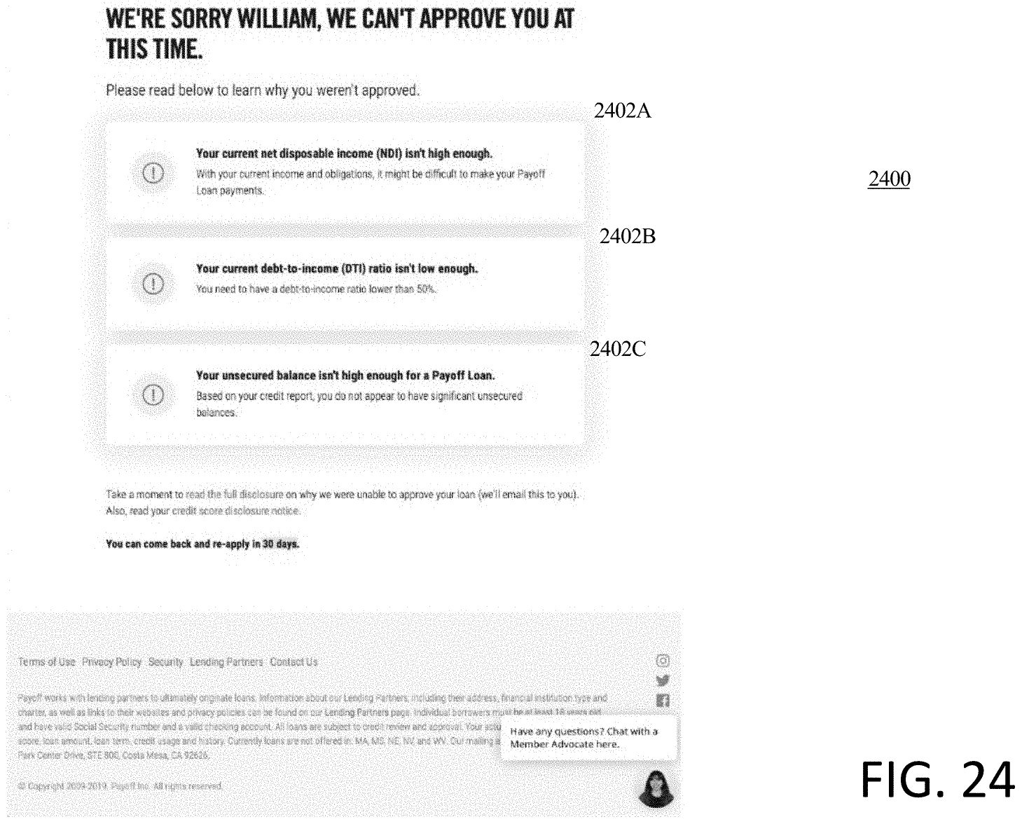

If the loan application is denied or fails, an adverse action and/or failure advice is provided to the borrower/debtor 102. FIG. 24 illustrates a plurality of adverse actions 2402A,2042B,2402C that can be provided to the borrower/debtor 102 including the adverse factor or reason for the denial. For example, the adverse factor of denial for the adverse action 2042A is that the current net disposable income (NDI) is not high enough. The current income and current obligations of the borrower would make it difficult to make loan payments. As another example, the adverse factor of denial for the adverse action 2042B is that the current debt to income (DTI) ratio is not low enough. The applicant does not have a debt-to-income ratio lower than fifty percent. Yet another example, the adverse factor of denial for the adverse action 2042C is that the unsecured credit balance of the applicant is not high enough for a loan. Based on the applicant's credit report, the applicant does not have significant unsecured credit balances. In another embodiment, if the loan application is denied, the borrower/debtor 102 is provided with improvement advice on how to improve his/her happy money score going forward.

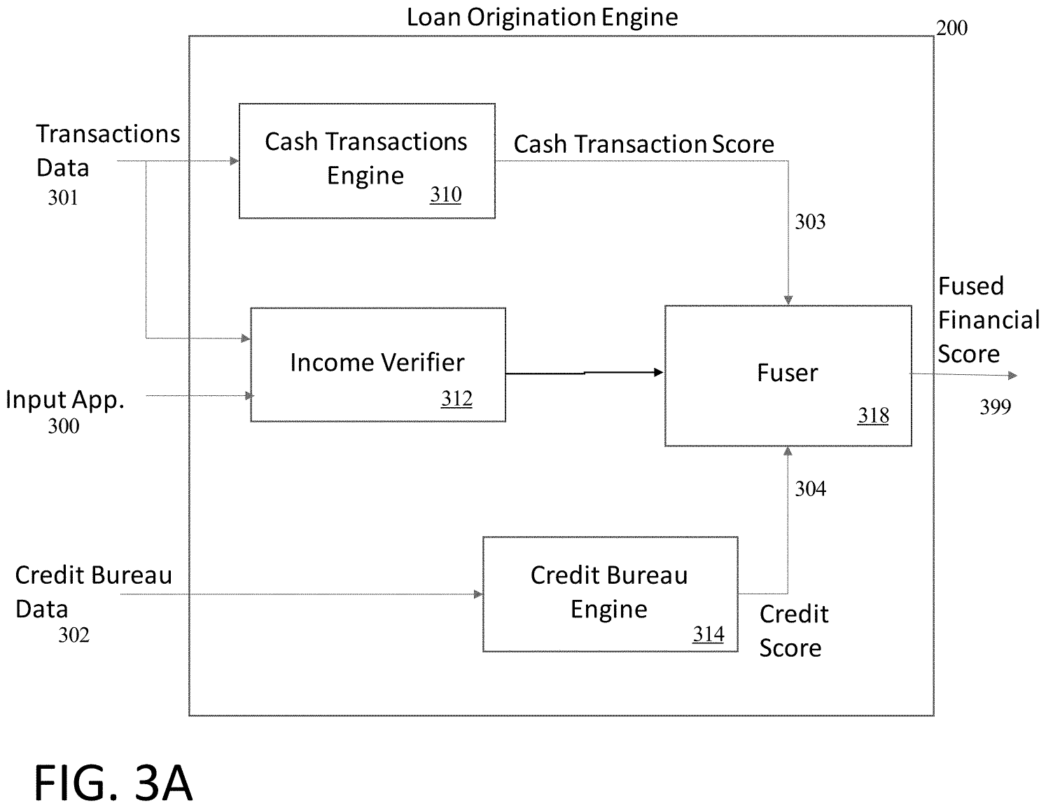

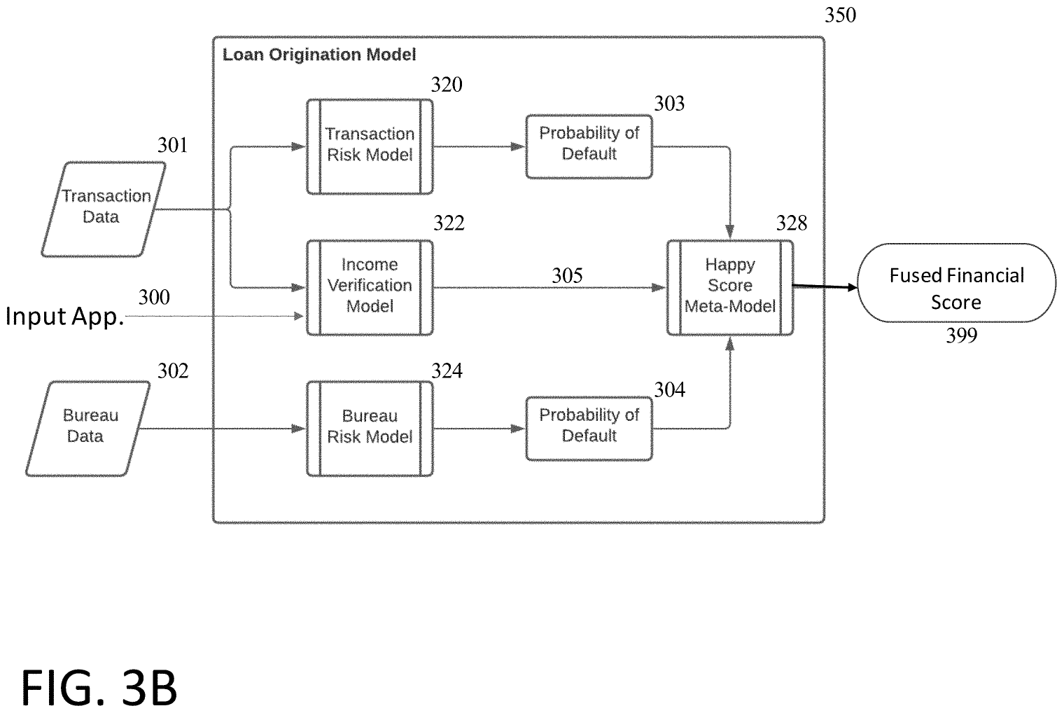

Referring now to FIG. 3A, in accordance with one embodiment, the loan origination engine 200 includes a cash transactions engine 310, an income verifier 312, and a credit bureau engine 314 all coupled in communication with a fuser 318 to generate a happy money score (alternatively referred to herein as a transactional financial score) 399. In accordance with another embodiment, the credit bureau data is unnecessary and the loan origination engine 200 is less the credit bureau engine 314. In yet another embodiment, the income verifier 312 is not needed when the transaction data input is sufficient and the cash transactions engine 310 is capable of determining a probability of default that can be readily translated into the happy money score 399.

Referring now to FIG. 3B, the loan origination engine 200 uses a machine learning model executed by at least one processor of the server, referred to as a loan origination model 350. Within the loan origination model 350, the processor further executes a transaction risk model 320 for the cash transactions engine 310, an income verification model 322 for the income verifier 312, a bureau risk model 324 for the credit bureau engine 314, and a happy money score meta model 328 for the fuser 318 in order to generate the happy money score 399.

The transaction risk model 320 and the cash transactions engine 310 receive the transactions data (e.g., income, expenses, assets, liabilities) to generate a first probability of default. The income verification model 322 and the income verifier 312 receives the transactions data 301 and the input loan application 300 for the given borrower/debtor to generate a measure of accuracy or inaccuracy of the data provided in the input loan application. The income verification model 322 also generates a calculated net income 305 using the transaction data 322 and the data provided on the input loan application if it is sufficiently accurate. The bureau risk model 324 and the credit bureau engine 314 receive bureau data (e.g., credit report with trade lines) from one or more credit reporting agencies to generate a second probability of default.

The happy money score meta model 328 and the fuser 318 receive the first probability of default 303, the second probability of default 304, and calculated net income 305 to generate the happy money score 399. The measure or score of income stability can be used as well (another probability of default based on income stability) but is used with verification segmentation. The happy money score meta model 328 and the fuser 318 combine and fuse together the different probabilities of default for a given borrower using a model into an overall probability of default. The fuser 318 and model 328, further translates the overall probability of default into a more intuitive score, the happy money score. The happy money score meta model 328 can be a linear model or a gradient boosted tree model. In accordance with one embodiment, the happy money score 399 is used in the decision making process of loan origination to decline or provide a borrower with a new loan from a lender.

Besides loan origination, the transaction risk model 320 for the cash transactions engine 310, the income verification model 322 for the income verifier 312, the bureau risk model 324 for the credit bureau engine 314, and the happy money score meta model 328 for the fuser 318 can be used independently or grouped in communication together in different ways to make other decisions regarding a user, such as for identification or background checks and for different users, such as a job applicant or a company. For example, bureau data 302 is used to evaluate consumers but not companies. Other information can be received about companies in order to evaluate the credit worthiness/risk of companies for receiving monetary loans from lenders by the system.

Financial Scoring with Transactions

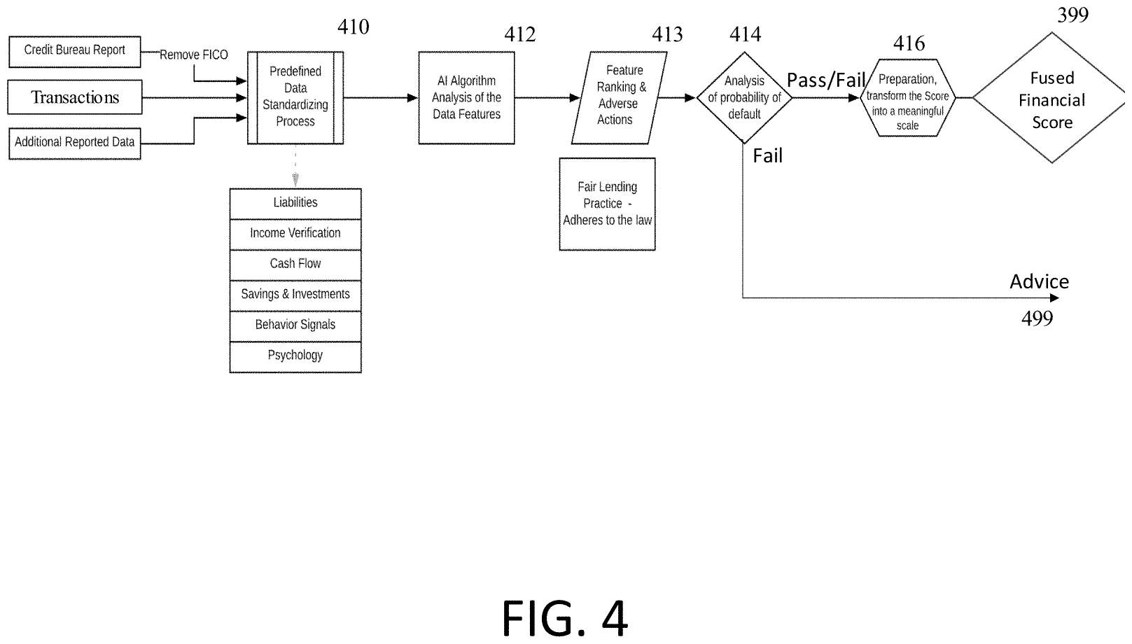

Referring now to FIG. 4, the overall process of generating the happy money score 399 based on a borrower's transactions is now described. One or more credit bureau reports 402 are received and the FICO score is removed to avoid undue influence. The borrower's transactions data 404 is received. Additional reported data 406 is received, including that provided in a loan application by the borrower. Additional reported data 406 may be psychometric data, obtained through a psychometric query process, such as that described in U.S. patent application Ser. No. 15/704,586, titled USING PSYCHOMETRIC ANALYSIS FOR DETERMINING CREDIT RISK, filed by John Buckwalter et al. on Sep. 14, 2017, now issued as U.S. patent Ser. No. 10/755,348; and U.S. patent application Ser. No. 15/983,887, titled INTERACTIVE VIRTUAL ASSISTANT SYSTEM AND METHOD, filed by Adam Zarlengo et al. on May 18, 2018, now issued as U.S. patent Ser. No. 10/678,570, both of which are incorporated herein by reference for all intents and purposes.

Using a predefined data standardizing process 410 the data is parsed into predefined standard forms to extract liabilities, income, cash flow, savings and investments, and other behavior signals of the transactions data. The data is also parsed in the predefined data standardizing process 410 to provide income verification against that submitted by the borrower on the loan application. If a psychometric loan application process is used, such as described in U.S. patent application Ser. Nos. 15/704,586 and 15/983,887 incorporated by reference, the predefined data standardizing process 410 can also parse the psychometric data into a predefined standard form of psychological data so that it can be further used to evaluate the borrower for credit worthiness.

At block 412, an artificial intelligence engine uses artificial intelligence and/or machine learning model executed by a processor to perform an analysis of data features over the parsed transactions data (e.g., liabilities, income, cash flow, savings and investments), behavioral data, and psychological data, if available. One or more of the data features can be predetermined data features that show adverse credit risks, such as checking account volatility, credit card paydown behavior, number of overdrafts of bank accounts, discretionary spending amounts, and obligatory spending amounts, for example. One or more of the data features can be predetermined data features that show positive credit risks in contrast with adverse credit risk, such as savings account balance, saving/investing behavior, and checking account balance, for example.

At block 413, financial features are ranked, a probability of default is generated, and adverse actions, if any, are identified/generated for each debtor/borrower. The ranking and the probability of default are generated in accordance with fair lending practices to comply with federal and/or state laws.

At block 414, the probability of default is analyzed based on the ranking of each borrower. Those borrowers that fail a level of acceptable risk or probability of default, with an adverse action, can be dropped out of the further process of loan origination and provided advice 499 about the adverse action. Those that pass the level of acceptable risk or probability of default, a passing action, can continue on in the loan origination process.

At block 416, the probability of default, normally in the range of zero (0) to one (1), is prepared and transformed using a mathematical translation into a score with a more meaningful scale, the happy money score 399. In one embodiment, the happy money score has a scale like a FICO like score in order for it to be more intelligible. In other cases, the happy money score can differ and use a different numerical range.

In the case of an adverse action, where a debtor/borrower is likely to be denied by his probability of default, a fail, the debtor/borrower can be provided with additional information (advice) about their happy money score. The one or more of data features that harmed the debtor/borrower the most in their happy money score can also indicated as advice. This advice can be used by the debtor/borrower to improve their probability of default/happy money score in order to pass through the loan origination process in the future. In another embodiment, the advice of the adverse action can be presented to the debtor/borrower without the associated happy money score 399.

Regarding block 412, examples of artificial/machine learning that are used in financial analysis, all of which that are incorporated herein by reference are: (1) Petropoulos, Anastasios, et al., titled A ROBUST MACHINE LEARNING APPROACH FOR CREDIT RISK ANALYSIS OF LARGE LOAN LEVEL DATASETS USING DEEP LEARNING AND EXTREME GRADIENT BOOSTING”, in Are Post-crisis Statistical Initiatives Completed, vol. 49 (2019): page 49-49, incorporated by reference, https://www.bis.org/ifc/publ/ifcb49_49. pdf; (2)_Ma, Xiaojun, et al. “STUDY ON A PREDICTION OF P2P NETWORK LOAN DEFAULT BASED ON THE MACHINE LEARNING LIGHTGBM AND XGBOOST ALGORITHMS ACCORDING TO DIFFERENT HIGH DIMENSIONAL DATA CLEANING, titled Electronic Commerce Research And Applications, vol. 31 (2018): pages 24-39, https://doi.org/10.1016/j.elerap.2018.08.002; and (3) James, G., Witten, D., Hastie, T., & Tibshirani, R. (2017), titled AN INTRODUCTION TO STATISTICAL LEARNING: WITH APPLICATIONS INR, New York: Springer, Chapter 8, Tree-Based Methods, Pages 303-335.

To determine the Happy money score 399, a Gradient Boosting Machine (GBM) model (utilizing non-parametric gradient boosted tree machine learning algorithms) is used with monotonicity constraints on predictor variables. GBM is a powerful modeling technique for credit scoring. There are several reasons a GBM was chosen over a traditional Logistic Regression model including (1) predictive power—a GBM model provides a better fit for the nonlinear relationships between predictor variables and target variables; (2) robustness—a GBM model is not as sensitive to outliers, making it easier to achieve a stable fit on the universe of the development data; (3) regularization—a GBM model is able to implement regularization to prevent overfitting; (4) domain knowledge guardrails—the monotonicity constraints in a GBM model ensure each candidate feature's direction is vetted and in some cases modified allowing for experiential judgment and domain knowledge to influence the model; and (5) transparency—the monotonicity constraints in a GBM model ensure that each feature in the model has a consistent interpretation and that decline reasons are coherent and actionable when presented to consumers.

A number of key model assumptions are used to determine the Happy money score 399, these include:
What was predictive in the data at the time of model development will continue to be predictive
The continued growth of the data underlying our predictors will not substantially change the reliability of the predictions
The relationship between the data, the variables derived from the data, and the outcomes will remain stable over the life of the model

During model development, a test dataset was used to determine and analyze the performance of the GBM model (model performance). Results demonstrated that the model performance of the test dataset was consistent compared to a training data set. All of the outcomes, evidence from the tests, and model performance reviews supported that the key model assumptions that were made were appropriate.

The GBM model used to determine the Happy money score 399 was tested and trained for consumers applying for an unsecured loan that would be used to consolidate credit card debt. The model, while having an ability to predict overall credit risk in a consumer population, is optimized for consumers who apply for an unsecured loan. Accordingly, the Happy money score 399 can be used in any process that measures a person's ability and desire to pay back a money loan. Further optimization of the GBM model can be made for businesses applying for loans given that some of the transaction data inputs (e.g., assets, liabilities, and cash flow) are likely to be different or at least vary differently from that of a consumer.

The GBM model leverages the same features/attributes for each borrower for the purpose of scoring a person's creditworthiness. Some of the key features/attributes used by the GBM model to determine the Happy money score 399 include:

| | Happy money |
|---|---|
| Attributes | score |
| Utilization | Yes |
| Spend Increase | Yes |
| Payment History | Yes |
| Overlimit History | Yes |
| Open Unsecured Installment Loan Trade | Yes |
| New Trade | Yes |
| NDI (Net Disposable Income) | Yes |
| Months Since Oldest Trades | Yes |
| Months Since Max Balance | Yes |
| Months Since Delinquency | Yes |
| Actual to Minimum Payment Ratio | Yes |
| Max Utilization | Yes |
| Inquiries | Yes |
| DTI (Monthly Debt-to-Income) | Yes |
| Delinquency History | Yes |
| Days Since Unsecured Installment Loan Inquiries | Yes |
| Credit Amount Stability | Yes |
| Credit Amount | Yes |
| Collection Activity | Yes |
| BTI (Unsecured Balance-to-income) | Yes |
| Balance Trend | Yes |
| Balance | Yes |
| Average Age of Trades | Yes |
| Available Credit | Yes |

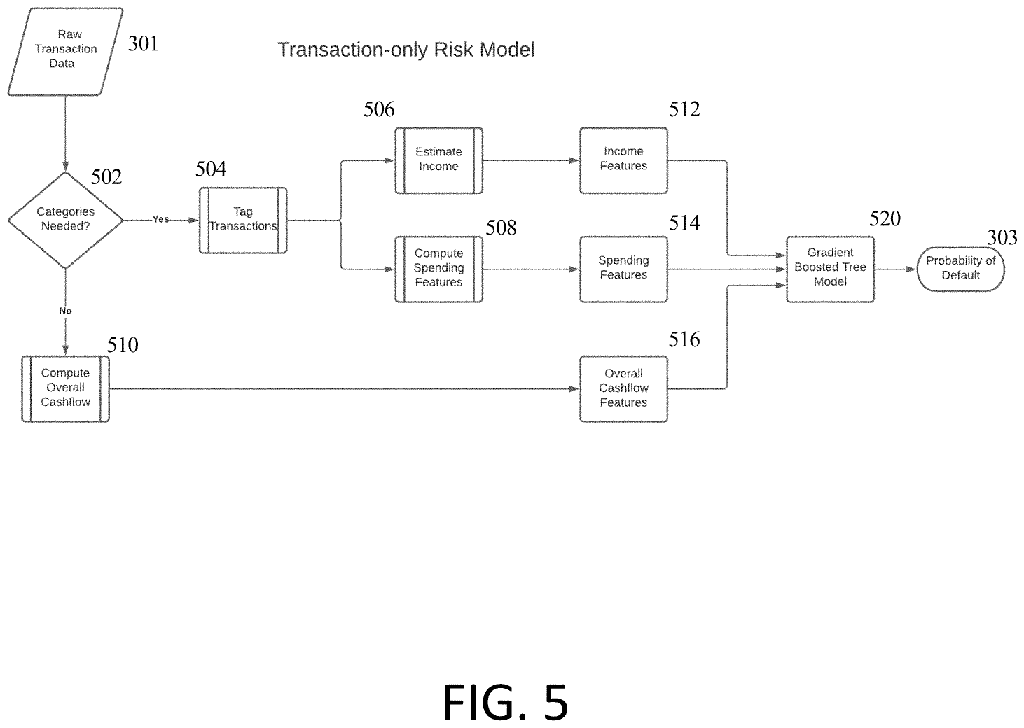

FIG. 5 illustrates a block diagram of the process performed by the cash transaction engine 310 shown in FIG. 3A and the transaction risk model shown in FIG. 3B. The raw transaction data 301 of the various financial transactions of a borrower/debtor are received.

At process block 502, a determination is made if insight on the categories is needed for spending transactions or credit/income transactions. If so, those transactions are passed to block 504.

At block 504, the transactions data is tagged using a tagging algorithm to distinguish the type of transaction. The transaction descriptions are analyzed, and the transaction is assigned to a predetermined income or expense category, such as paycheck, fast food purchase/expense, or rent/housing expense. With the tagged and categorized income and expense transactions, a monthly/annual income can be estimated, and a monthly/annual spending can be estimated.

At block 506, an estimate of total monthly (periodic) income can be made by summing the credit/income transactions for the prior months, looking for the weekly, biweekly, or monthly paychecks and other income, such as interest on investments. Other income computations for other predetermined periods (week, biweekly, bi-monthly, annual, quarterly, semiannual) can be made. The tagged income transactions can be grouped together with the computed income totals as income features along with the income total for the risk model.

At block 508, concurrently in parallel with income, an estimate of total monthly (periodic) expenses can be made by summing together the prior monthly expense/payment transactions. Other computations of expenses can be made for other predetermined periods (week, biweekly, bi-monthly, annual, quarterly, semiannual). The tagged expense transactions can be grouped together with the computed expense totals as expense/spending features for the risk model.

At block 510, disregarding the descriptions of the transactions as to where the money is coming and going, the overall periodic cash flow (e.g., weekly, biweekly, monthly, bi-monthly, quarterly, semiannually, annually) for each available period can be computed by the server system. The algorithm broadly looks at how much money is coming in and going out and the various patterns of cash flow. These computed overall cash flows for each predetermined period are saved as overall cashflow features for the risk model.

At block 520, a machine learning model receives the income features 512, the spending/expense features 514, and the overall cashflow features 516 and generates the first probability of default 303, a cash flow/transactions probability of default, for the given borrower/debtor based on the received features. In one embodiment, the machine learning (artificial intelligence) model is a gradient boosted tree model that receives all the financial features associated with the transactions to generate the cash flow/transactions probability of default for the given borrower/debtor. A gradient boosted tree model for machine learning is described in Petropoulos, Anastasios, et al., as well as Ma, Xiaojun, et al. incorporated herein previously by reference for all intents and purposes.

### Automated Income Verification and Segmentation

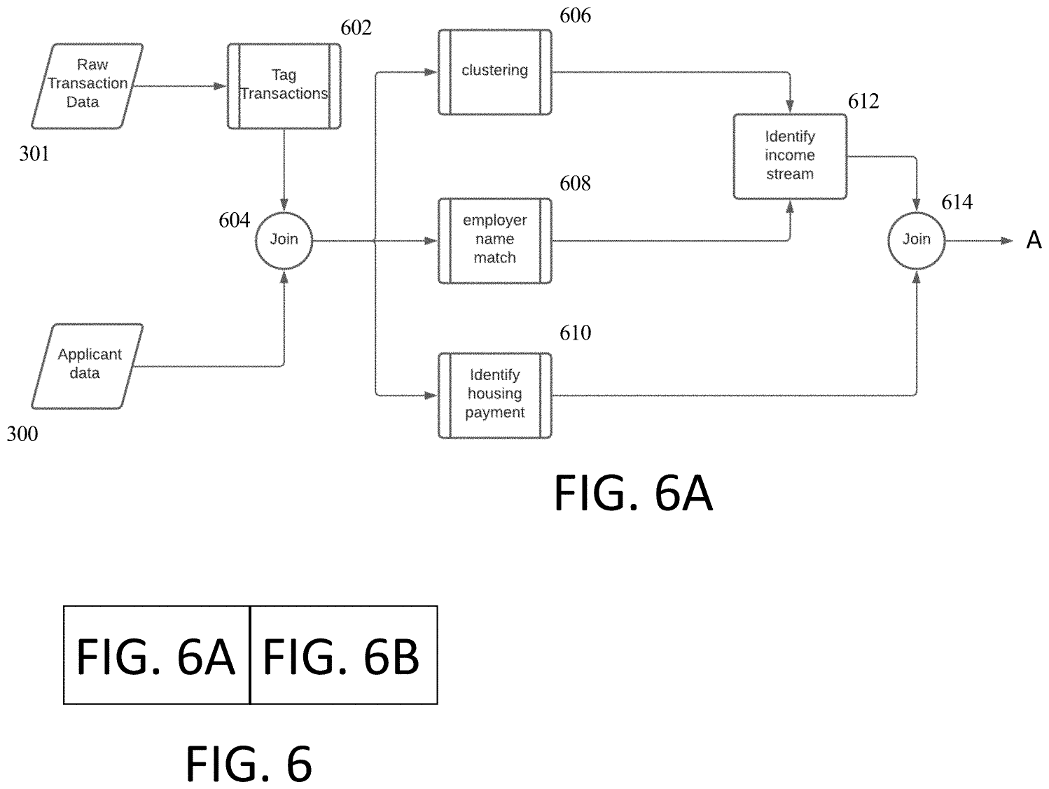

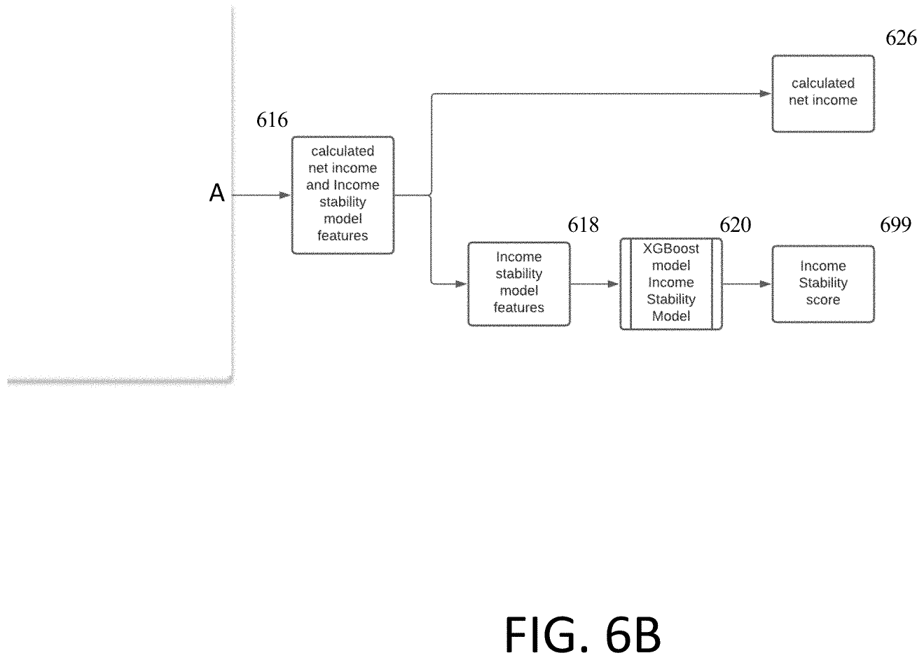

FIG. 6, consisting of FIGS. 6A-6B, illustrates a flow chart of the process of income verification of a borrower performed by the income verifier 312. The income verifier 312 receives the raw transactions data and the input loan application data (applicant data) in order to calculate a net income for one or more periods and generate an income stability score.

The income verifier 312 uses the calculated net income and compares it with the self-reported or input net income on the loan application provided by the borrower. If the self-reported net income is within one or more threshold (tolerance) levels of the calculated net income, the income may be stated as verified and the borrower may pass further on in the loan origination process. If the self-reported net income is over exaggerated, the borrower may be refused or undergo a more restrictive analysis for a. loan in order to understand why there is such a. discrepancy between calculated net income and -self-reported net income. Accordingly, borrowers having a high confidence level in income verification can be automatically verified, while borrowers having lower or the lowest confidence level in income verification can be singled out for a further manual verification by one or more human auditors.

Underlying the calculations made by the income verification model is the operation of verification segmentation. Verification segmentation is the practice of applying distinct verification treatment to customers of different risk levels. In this framework, applicants/debtors/borrowers are segmented into three groups: fast pass, regular check and enhanced scrutiny. Customers eligible for fast pass have the privilege to skip certain check items—for example, bank statement analysis—and thus have a better chance to get approved for funding. In contrast, a stricter verification is added to customers whose credit capacity and willingness to pay/save appears concerning.

As shown in FIG. 6A, the cash transactions data 301 and the borrower applicant data from the input application 300 are both received by the income verifier 312.

At block 602, the transactions data is tagged using a tagging algorithm to distinguish the type of transaction. The transaction descriptions are analyzed, and the transaction is assigned (tagged) to a predetermined income or expense category.

At block 604, the input applicant data from the loan application is joined to the tagged transactions data, such as self-reported income, employer, and the resident state of the borrower, for example. The income streams from the tagged transactions data can be determined in a couple of ways.

At block 606, a clustering algorithm is used to determine income streams from the tagged transactions data. The clustering algorithm looks for patterns trained from a. set of known transactions data. The desired patterns of data are looking for a stable income stream as to time and amounts.

At block 608, the transaction descriptions are analyzed by another algorithm to match the name of the employer provided in the applicant data. Direct deposits with the employer name are sought. Paychecks deposited into the bank accounts can be sought to match against the given employer name of the loan application. For example, if TARGET is the given employer on the loan application, that name is sought in the descriptions of the tagged transaction data and direct deposits or check deposits to bank accounts.

At block 610, the transaction descriptions are analyzed by another algorithm to match given housing payment information from the input loan application to identify the housing payments that the borrower has made.

At block 612, the patterns of data found by the clustering algorithm and the identified deposits of employment checks are used together to identify the major income streams.

At block 614, the major income streams and the housing payments are joined together and passed to block 616 shown in FIG. 6B.

Referring now to FIG. 6B, at block 616 the net income 626 of the borrower/applicant client is calculated for various periods. At block 616, various features 618 related to the stability of income are calculated as well for the income stability model. The calculated net income 626 is passed out of the income verifier.

The income stability features 618 that are calculated from the income stream are parsed and passed on to income stability model algorithm 620.

At block 620, a gradient boosted tree model is used with the income stability features 618 to generate an income stability score 699. The gradient boosted tree model is a risk model, Given the features of a borrower's income, the gradient boosted tree model generates an income stability score indicating how credit worthy or risky the given borrower is based on income.

Underlying the calculations made by the income verification model is the operation of verification segmentation. As mentioned herein, verification segmentation is the practice of applying distinct verification treatment to customers of different risk levels. For borrowers having lower risk levels, certain check items may be skipped. For borrowers having higher risk levels, a stricter verification may be used for certain check items.

It is a goal of verification segmentation to increase verification capacity and reduce workload pressure of manual interventions in the income verification process by auditors/accountants/employees. This can be accomplished by computerizing independent steps that take a long time with a manual verification by auditors/accountants/employees. It can be further accomplished by fully verifying by computer the easily verifiable applications, the low hanging fruit, of borrower applicants that clearly have better probabilities of making payments. Accordingly, verification segmentation an underwriting decisions for as many borrower applicants as possible using an auto-fund mode. This can considerably reduce the time and costs associated with originating loans.

The verification segmentation logic combines four models to rank an applicant into one of three verification categories: fast-pass; normal; and additional review. The four models used by the verification segmentation logic are the Income Verification Model (compares calculated net income with that provided in the loan application against a threshold level percentage of accuracy), an Industry Classification Model (e.g., job, career, field of work); Use-of-Loan Model (Model that estimates probability that the loan will actually be used to pay off credit card debt); and an income stability model (verification score model) described with reference to FIG. 6. A decision tree used for the Verification Segmentation process uses these four data science models to adjust the strength or intensity of income verification.

Some of the key performance indicators that are indicative of achieving the goals of verification segmentation are
Total response time to borrower applicant
Time to first response
Percentage of completed Application Verification to 95th %
Cost for processing application
Measured in amount of agent time spent on each application
Estimated time based on discrete manual tasks
Funnel capacity (leads/tinge)
how many applications can be processed (number of verified per agent per day)
% of automation (new report based on data)
% of allies that get a fully automated. decision
% of total verification steps performed through automation

Pseudocode for an exemplary income verification decision is:

```
If model data is available:
  If (stated income − model income)/stated income <= 15% then pass
  else −> fail
else, if third-party-verified-income data is available:
  If (stated income − third-party-verified income)/stated income <= 15%
  then pass
  else −> fail
=======
((this section can be optional))
If third-party calculated income is available, the following pseudo code
can be further executed.
  If (stated income − third-party calculated income)/stated income <=
  15% then pass
  else −> fail
=======
else −> manual verification
```

### Credit Bureau Engine

The credit bureau scores, such as FICO, do not consider cash flow of a borrower. The happy money score considers cash flow to be important, but also considers a borrower's past credit history that can be obtained from one or more credit bureaus. Normally, a probability of default for a borrower is considered important for loan origination. The happy money score can be translated (inverted and scaled in magnitude) to a scale similar to that of a FICO score from a range of probability of default (e.g., 0 to 1) into a range of positive scores (e.g., 0 to 1000). In this discussion we consider how the credit bureau engine 314 reads credit bureau scores and generates an improved credit score 304 that can be fused together with the cash transactions score.

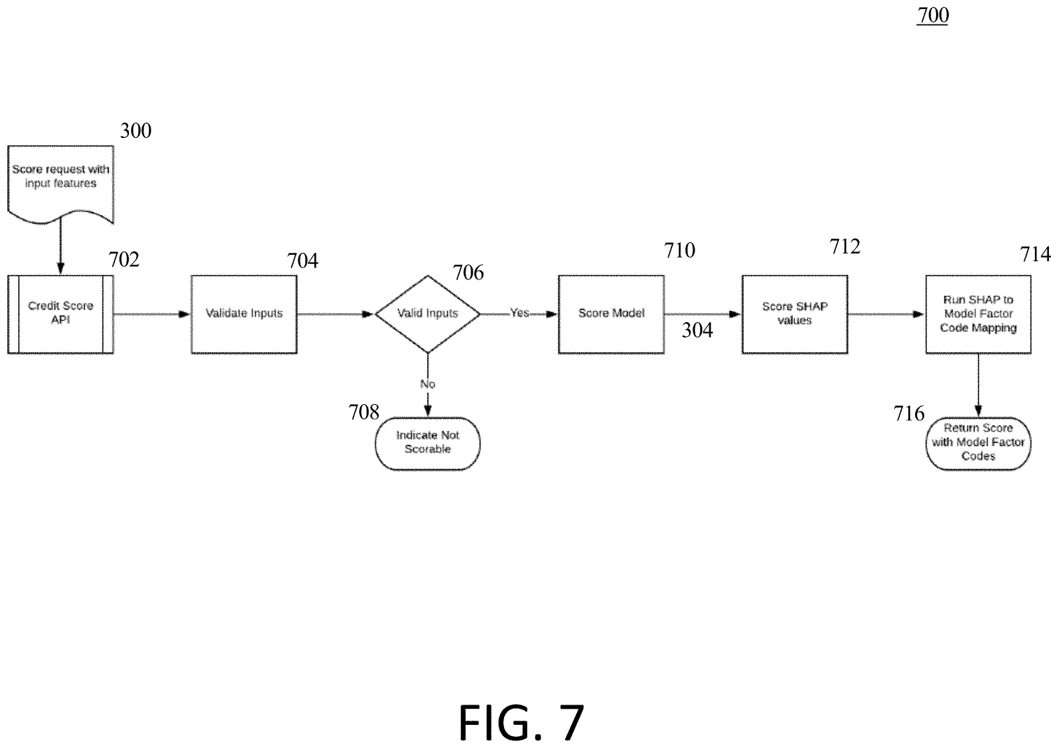

Referring now to FIG. 7, a functional block diagram of the method 700 performed by the credit bureau engine 314 is shown. At step 702, a credit score application programming interface (API) of the credit bureau engine 314 receives a score request from the borrower with the borrower's input information, such as from the borrower's input loan application 300. One or more credit bureau scores for the borrower are pulled from one or more credit bureaus. At step 704, the borrower's input information from the application is validated against other sources of information about the borrower, such as for example, debt from credit bureaus sources, income from bank statements, employment from employers, and spending from credit sources. Over 100 bureau credit features (variables) are used such that a FICO score can be eliminated from the credit score model 710.

At step 706, a determination is made if sufficient valid inputs are available to use a credit model in the generation of the happy money score. If not, the process goes to step 708 where an indication is provided that the insufficient valid inputs were made available for the given borrower in order to use credit bureau data as part of the information to generate the happy money score. If yes, sufficient valid inputs are available, the process goes on to step 710.

At step 710, a credit scoring model is used that emphasizes applicant's ability and willingness to pay by assessing a potential borrower's capacity, condition, and character. The credit model considers cash flow where other credit models ignore cash flow. The following table indicates the credit features emphasized by the model and their assessment:

| Credit Features | Assessment |
|---|---|
| Cash Flow (NDI, BTI, DTI) | Capacity |
| Behavioral (Lie Detector, Over Limit) | Condition and |
| | Character |
| Balance trend (Number of non-mortgage balance | Capacity and |
| increases last 3 months) | Condition |
| Inquiry (Number of inquiries in past 6 months includes | Condition |
| duplicates) | |
| Derogatory | Character |
| Credit amount (Average credit amount of open credit | Capacity |
| card trades verified in past 12 months) | |
| Credit history (Months since oldest credit card trade | Character |
| opened) | |
| Recent trade (Months since most recent credit card trade | Capacity and |
| opened) | Condition |
| Utilization (Utilization for open revolving trades | Capacity and |
| verified in past 12 months) | Character |

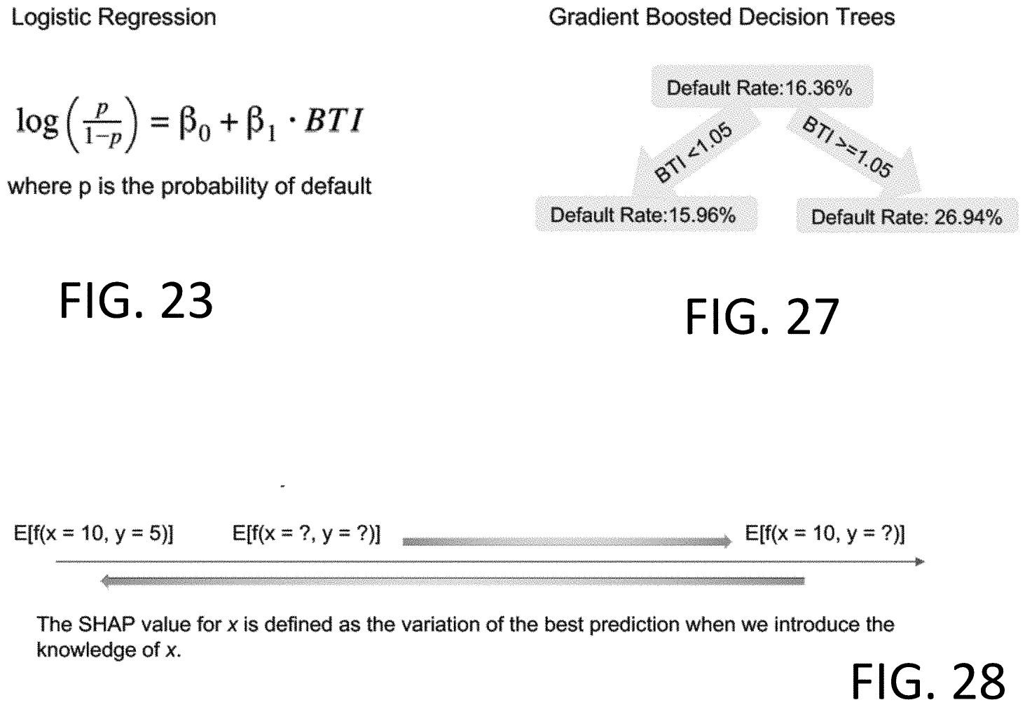

A number of different machine learning models can be used to model credit risk and obtain a probability of default for a borrower and translate the probability of default into a credit score. A mathematical algorithm can be used to model risk of a feature to determine a probability of default. FIG. 23, for example, indicates a logistic regression that can be used to model the probability of default based on a debt balance to income (BTI) ratio. Alternatively, a machine learning artificial intelligence model can be used to risk and determine a probability of default based on a debt balance to income (BTI) ratio.

The credit model is a gradient boosted decision tree model that uses a gradient boosted tree algorithm. FIG. 27 illustrates a single branch of classification of a gradient boosted decision tree for the debt balance to income (BTI) ratio, for example. Given a base default rate of 16.36%, if the BTI ratio is less than 1.05, then the default rate is modified to 15.96% for the borrower. If on the other hand, the BTI ratio for the given borrower applicant is greater than or equal to 1.05, then the default rate is increased to 26.94% for the given borrower applicant.

Generally, the gradient boosted tree algorithm combines a gradient descent algorithm with a boosting algorithm. Gradient descent is an iterative optimization algorithm. It is a method to minimize a function having several variables. Thus, Gradient descent can be used to minimize the cost function. It first runs the model with initial weights, then seeks to minimize the cost function by updating the weights over several iterations. A boosting model or algorithm builds an ensemble of weak learner classifier models where the misclassified records are given greater weight (‘boosted’) to correctly predict them in later models. These weak learners are later combined (assembled into an ensemble) to produce a single strong learner classifier model. There are many Boosting algorithms such as AdaBoost, Gradient Boosting, and XGBoost. In one embodiment, the credit model uses an XGBoost implementation of a gradient boosted tree algorithm that is an efficient implementation. In another embodiment, the credit model uses an AdaBoost implementation of a gradient boosted tree algorithm. In yet another embodiment, the credit model uses an Gradient Boosting implementation of a gradient boosted tree algorithm.

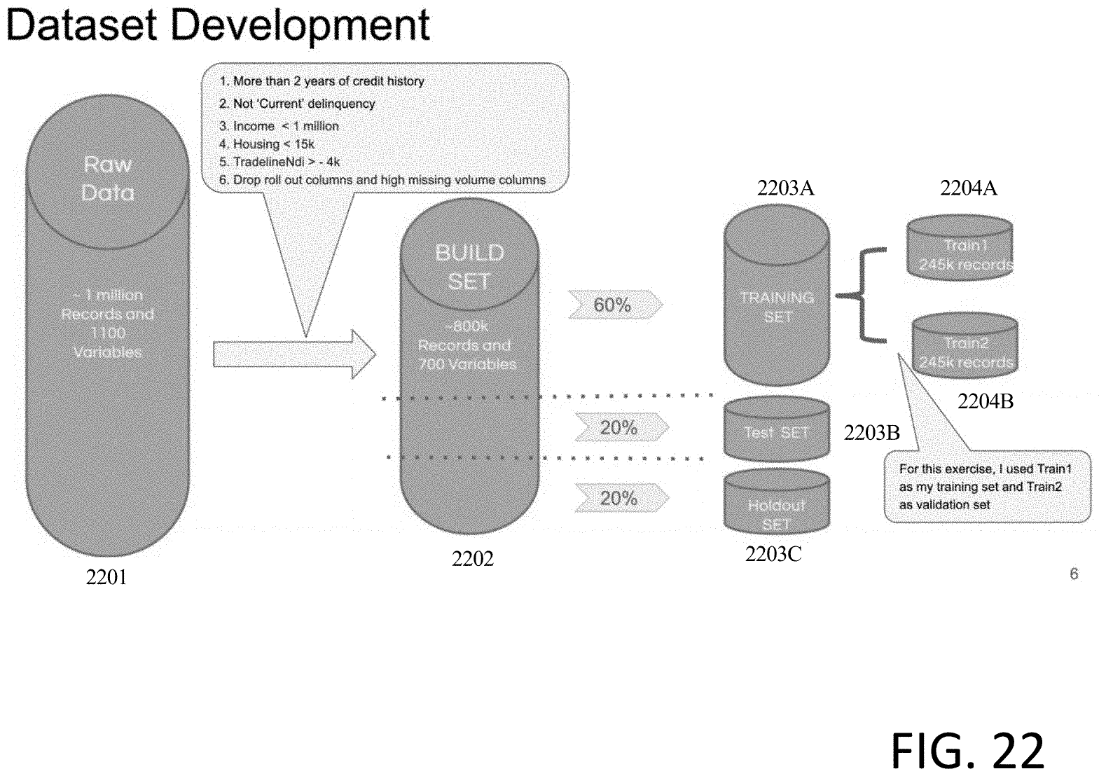

The credit model uses a background population of borrowers that is used to train the credit model. Loan applications that are approved by the credit model are chosen as the background population of borrowers to train the model. FIG. 22 illustrates how a dataset of borrowers in loan portfolios can be generated to train, verify, and test the machine learning model. A raw data set database 2201 of over a million anonymous borrowers with debt, credit, expense, and income histories providing about 1100 financial variables is formed from financial data base sources. Borrowers from the raw data set 2201 are selected for a build set data base 2022 based on 1) more than 2 years of credit history, 2) no current delinquency, 3) income less than 1 million, 4) housing expense less than $15K per month, and 5) tradeline net disposable income (Ndi) greater than negative $4 k. Certain features in certain columns may be dropped for the borrows in the build set database 2202, such as those with high volumes of missing information. The build set database 2202 of borrowers can be reduced down to about 800 k records of borrowers and about 700 variables.

The build set database 2202 of borrowers can be divided up such that a first portion (e.g., 60%) of a plurality of borrowers is a set used as a training set 2203A, a second portion (e.g., 20%) of a plurality of borrowers is set used as a test set 2203B, and a third portion (e.g., 20%) of a plurality of borrowers is set used as a holdout set 2203C. The training set 2203A can be further divided up into a training set 2204A for the model and a validation set 2204B for the machine learning model.

A base model is created based on a subset of the original dataset which is used to make predictions on the whole dataset. Errors are calculated and observations which are incorrectly predicted, are given higher weights. Another model is created which tries to correct the errors from the previous model. Similarly, multiple models are created, each correcting the errors of the previous model. The final model (strong learner) is the weighted mean of all the models (weak learners). The model shown in FIG. 27 can be considered a weak learner. A plurality of these weak models can be generated based on a training set and assembled together as a strong model, an ensemble model. Each financial, credit, income, and cash feature can have a plurality of weak learning models that are weighted and assembled together to form an overall machine learning model for the happy money score. In this manner, the happy money score can be generated for a borrower based on the borrower debt, cash spending, and income cash inputs on a loan application. The process then goes on to step 712.

At step 712, shapley additive explanation (SHAP) values are scored in order to add further meaning as to why the happy money score for the given borrower was generated. Recall, machine learning models are being used to generate the happy money score and it is helpful to provide reasoning why a given happy money score is generated. SHAP values are further explained in “A Unified Approach to Interpreting Model Predictions”, published Nov. 25, 2017, by Scott M. Lunderberg and Su-In Lee at the 31^{st} Conference on Neural Information Processing Systems (NIPS 2017), incorporated herein by reference. The borrower's financial features are ranked in importance by assigning a weight to each feature. A positive/negative weight indicates that the corresponding feature informed of a higher/lower probability of defaulting (0 is no default probability and 1 is a certain default probability). Weights are assigned according to the following criterion: The weight of a feature is defined as the change in the prediction induced by knowing the value taken by that feature. The values of the weights so obtained are called SHAP (SHapley Additive exPlanations) values.

Referring now to FIG. 28, a diagram is illustrated to further explain a SHAP value. Consider for example, a model f with two features x and y. For a specific individual, values for the features x=10 and y=5. We ask the question was x more important or was y more important in making a prediction E for the individual using the model f? In order to answer this question, we can take the following approach: What is the best guess we can make for E if we don't know any of the features? What is the best guess we can make for E if we now know x? What is the best guess we can make for E if know both x and y? The SHAP value for x is defined as the variation of the best prediction of E when we introduce the knowledge of x.

With game theory concepts, it can be shown that SHAP values are the unique weights with local accuracy, missingness, and consistency. Local accuracy can be shown by summing SHAP values together to produce the outcome of the original model. Missingness can be shown if a credit feature that is not used by the model is then assigned a SHAP value equal to zero. Consistency can be shown if a model changes such that it gives more importance to a certain feature then the corresponding SHAP value for that feature should not decrease. After determining the SHAP values, the process then goes on to step 714.

At step 714, the SHAP values that are generated or scored are mapped to one or more model factor codes of a plurality of model factor codes in order to explain the SHAP values for the given borrower. The process then goes to step 716.

At step 716, the happy money score and the one or more model factor codes are returned to the system and can be presented to the borrower if just a happy money score was requested. Otherwise, the process can further go onto loan origination in the case that the happy money score for the given borrower indicated a level of risk worth taking for the use of the loan. If there is an adverse action, the SHAP values mapped to the model factor codes can be used to provide advice to the applicant borrower to improve his happy money score in the future.

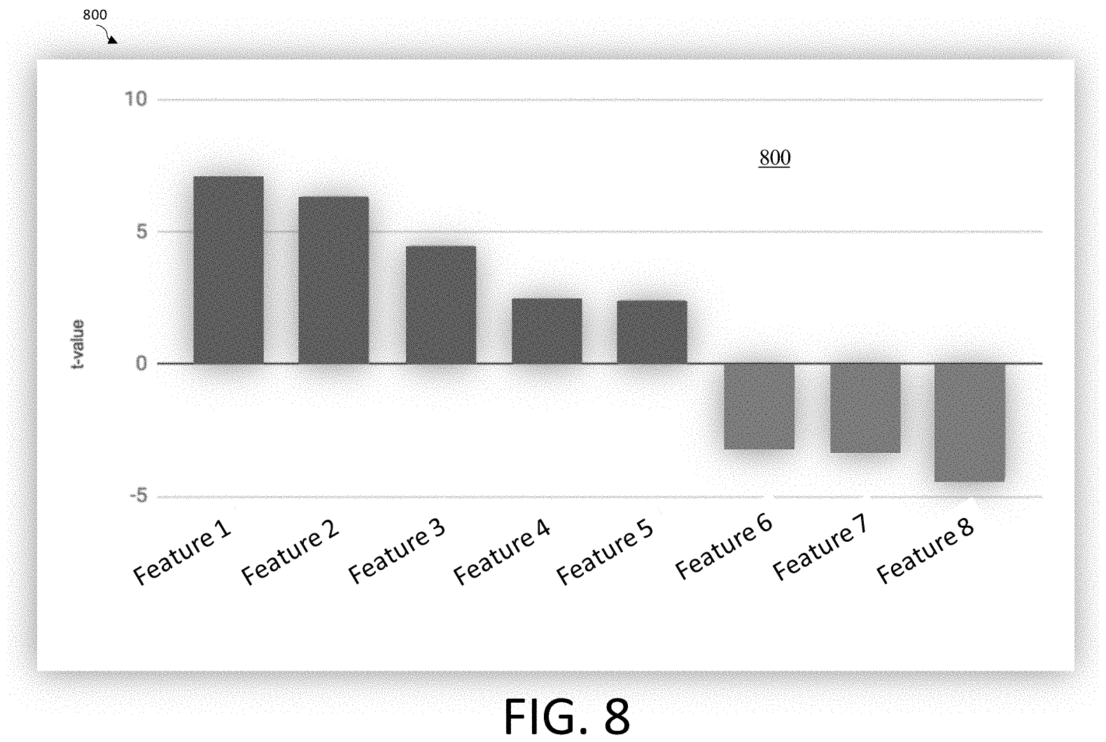

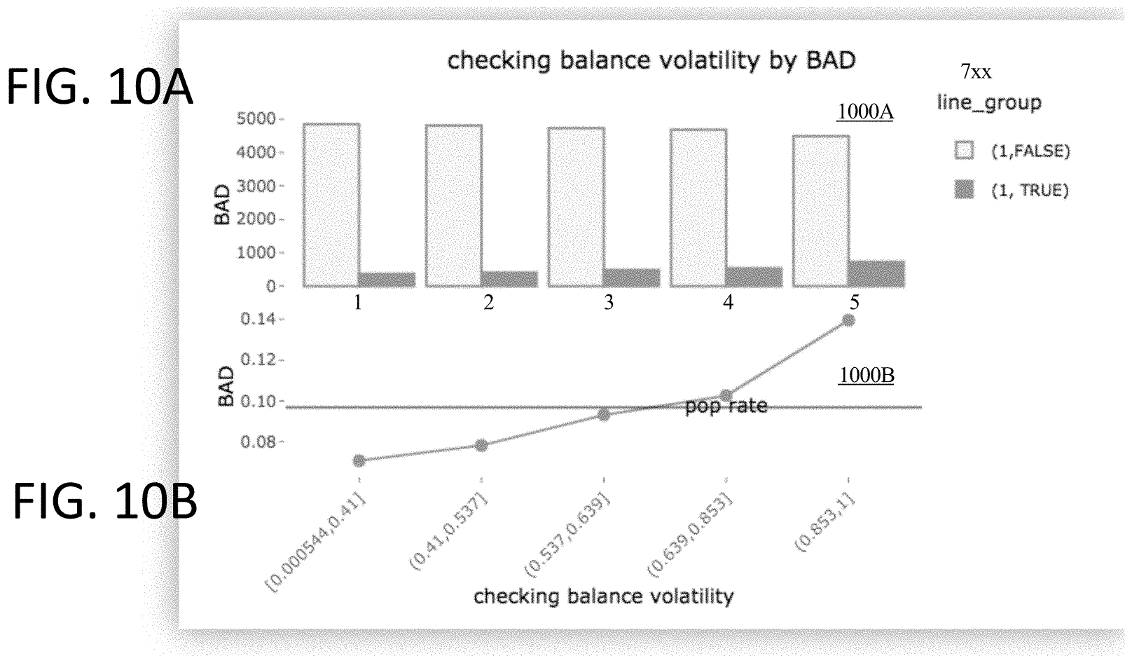

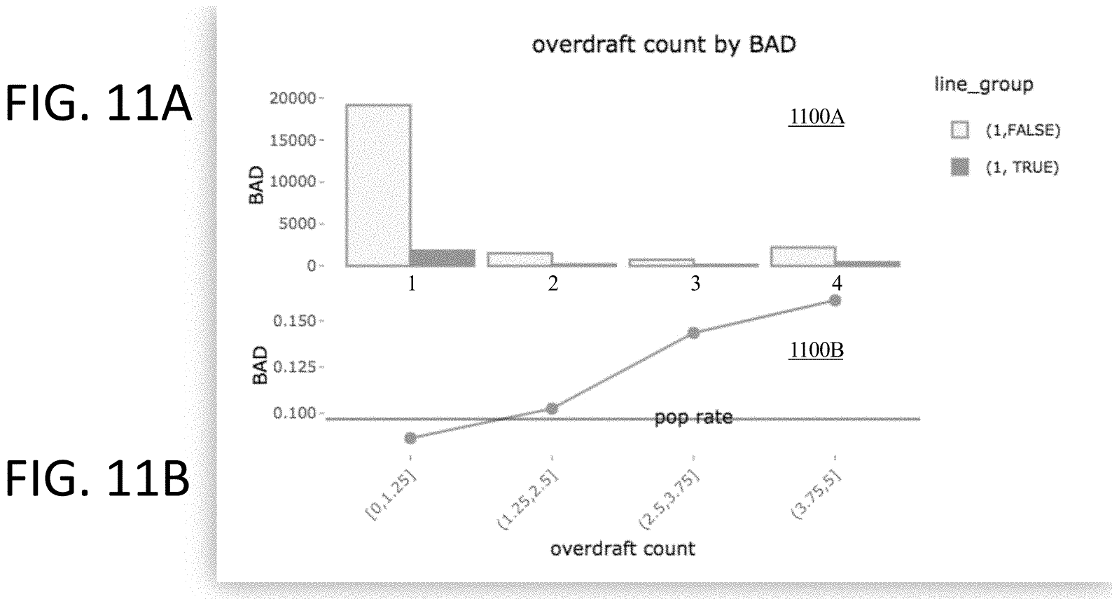

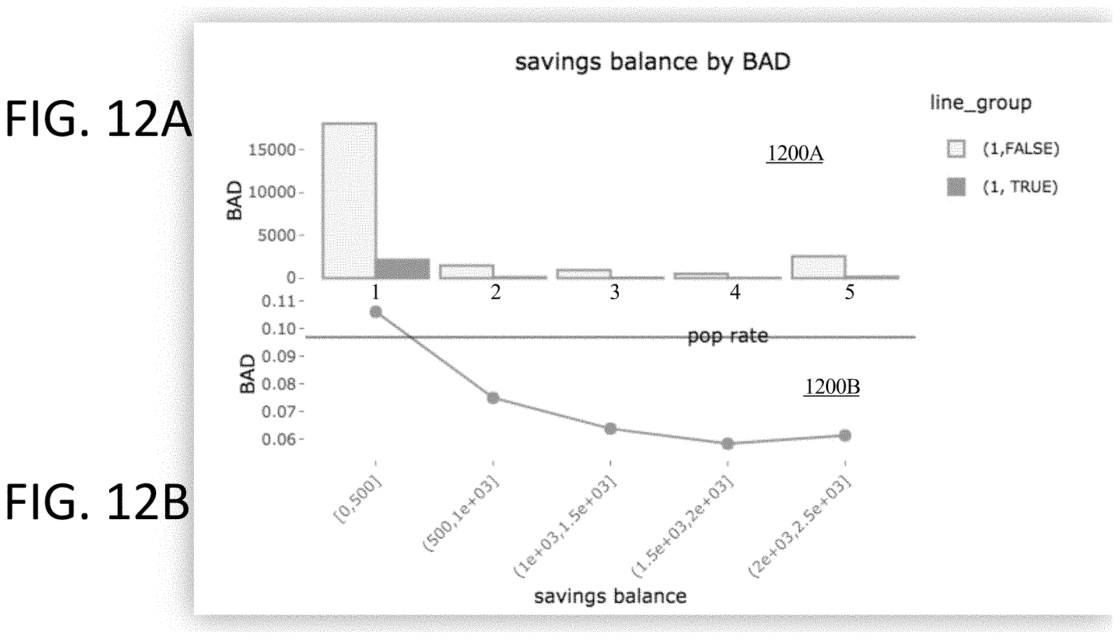

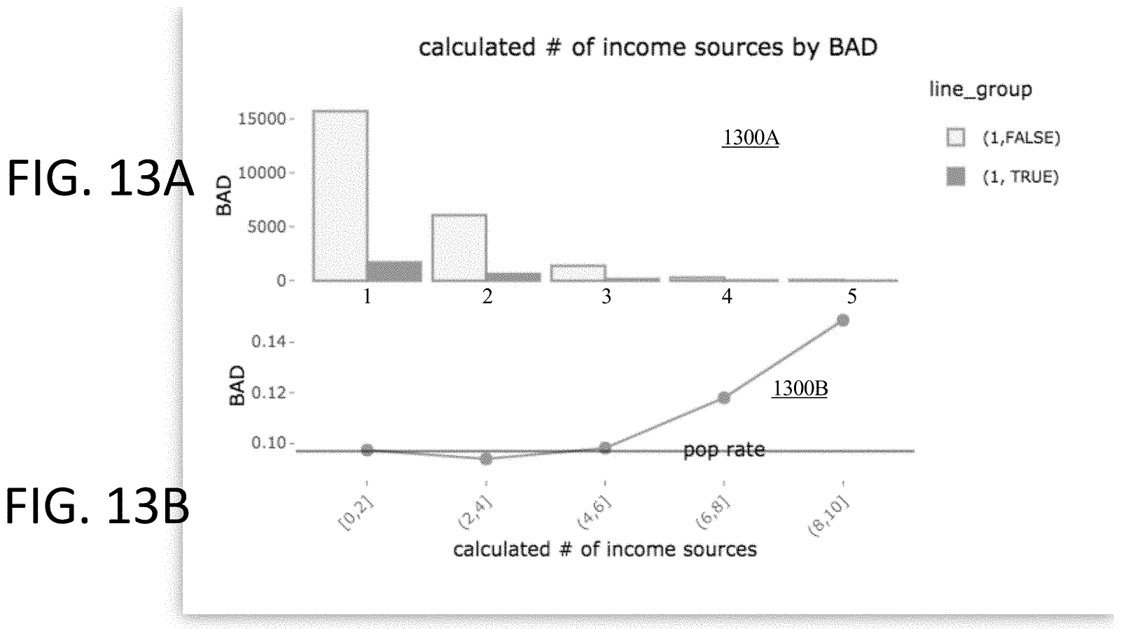

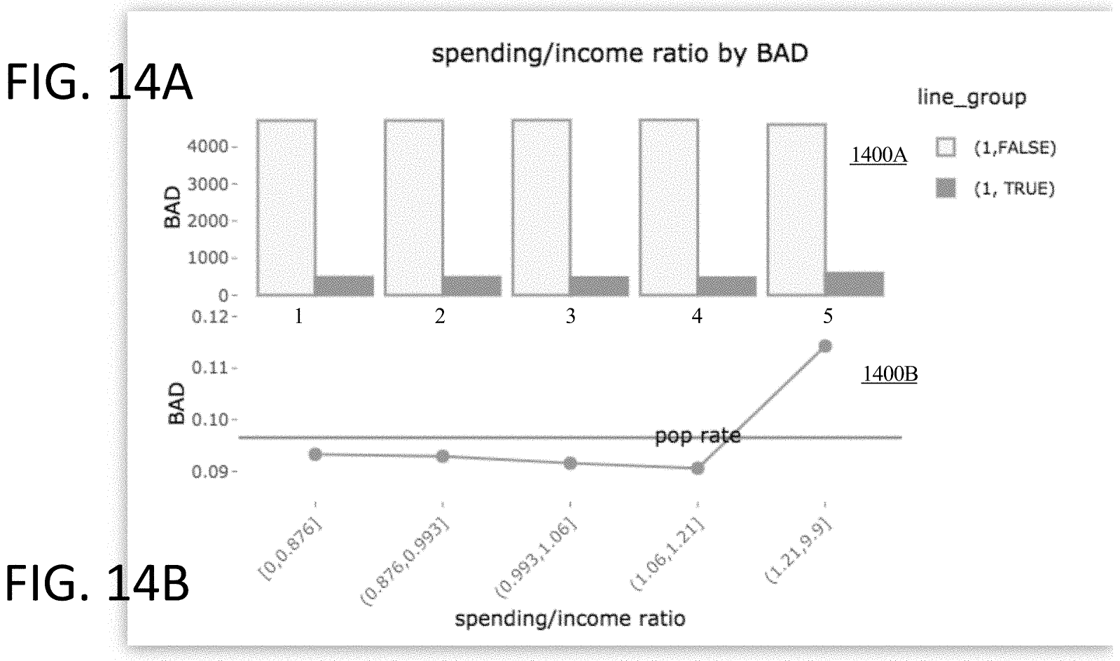

FIG. 8 is a user interface of an example chart 800 illustrating financial transaction features of interest and their contribution strength (t-value) to a probability of default. An administrator/user can use chart 800 to build, inspect, update, and/or calibrate a transaction model. The system can run a transaction score model by using financial transaction features of interest to form a happy money score (aka, fused score or combined score). A feature of interest may be referred to as a predictor. Example features of interest include, without limitation, checking balance volatility (e.g., FIG. 10A), overdraft count (e.g., FIG. 11A), savings balance (e.g., FIG. 12A), number of income sources (e.g., FIG. 13A) spending/income ratio (e.g., FIG. 14A), and so on. A user interface is the location on a computer device where a user can interact with a computer, website, and/or software application.

The system analyzes a consumer's transactions and wealth for a time period and can occasionally provide results of the analysis in graphical, textual, and/or audio form. The system can also, or alternatively, store the results in the background and use the results to calculate a happy money score. Assets (e.g., savings and checking accounts) and transactions history are incredibly predictive of risk and financial outcomes. The system can track transactions and assets more often than credit, which is typically tracked only once per month. For example, the system may track a person making transactions weekly, daily, hourly, minutely, and so on.

In the embodiment of FIG. 8, the results in the chart 800 are that of a logistic regression model. The system has analyzed a consumer's predictors (e.g., transactions and wealth) for a time period (e.g., 30 days, 60 days, 90 days, etc.). The horizontal axis includes features/predictors for predicting risk for a consumer. The horizontal axis may include, for example, the following predictors for the consumer: checking account volatility as Feature 1, credit card paydown behavior as Feature 2, overdrafts as Feature 3, discretionary spending as Feature 4, obligatory spending as Feature 5, savings account balance as Feature 6, saving/investing behavior as Feature 7, and checking account balance as Feature 8. The vertical axis shows the t-value for each predictor.

In statistics, a t-value represents the significant difference from the population means (e.g., if multiple features/predictors are sampled) or between the population mean and a hypothesized value (e.g., if only one feature/predictor is sampled). The t-value measures the size of the difference relative to the variation in the sample data. For example, a t-value magnitude in FIG. 8 is the significant difference between one predictor in the model relative to the average of all the predictors in the model. Put another way, a t-value is simply the calculated difference represented in units of standard error. The greater the magnitude of the t-value, the greater the evidence is against the null hypothesis (e.g., normal risk). This means there is greater evidence that there is a significant difference from normal. The closer the t-value is to zero (e.g., normal risk), the more likely there is not a significant difference from normal.

In FIG. 8, Features 1-5 (predictors 1-5) show positive t-values. Features 6-8 (predictors 6-8) show negative t-values. A positive t-value mean these Features can predict a higher-than-normal risk of a borrower. For example, Feature 1 (predictor 1) has a t-value of about +7, indicating Feature 1's strength in predicting high risk is 7 relative to other t-values on the chart. In this example, Feature 1 is the strongest predictor of high risk. For instance, if Feature 1 is the consumers checking account volatility, then the checking account volatility is the strongest predictor of high risk. The t-value of +7 is an example of a target variable.

The negative t-values for Features 6-8 means these Features are predicting a lower-than-normal risk for the borrower. For example, Feature 8 (predictor 8) has a t-value of about −4, indicating Feature 8's strength in predicting low risk is a magnitude of 4 relative to other t-values on the chart. In this example, Feature 8 is the strongest predictor of low risk. For instance, if Feature 8 is the consumer's checking account balance, then the checking account balance is the strongest predictor of low risk for this borrower.

Instead of a logistic regression model like in FIG. 8, the system can run a gradient boosted tree model, which has several advantages over a logistic regression model. Boosting means combining a learning algorithm in series to achieve a strong learner from many sequentially connected weak learners. In a gradient boosted tree model (e.g., gradient boosted decision tree algorithm), the weak learners are decision trees. Each tree attempts to minimize the errors of the previous tree. Trees in boosting are weak learners. However, adding many trees in series while each tree focuses on the errors from the previous tree makes boosting a highly efficient and accurate model. Every time a new tree is added, the tree fits on a modified version of the initial dataset. Since trees are added sequentially, boosting algorithms learn slowly. In statistical learning, models that learn slowly perform better.

Advantageously, a gradient boosted tree model has a greater predictive power than a logistic regression model. Greater predictive power typically results in increased volume approved by the credit policy (e.g., increased access to credit). A gradient boosted tree model provides a better fit for the nonlinear relationships between predictor variables and target variables. A gradient boosted tree model is not sensitive to multicollinearity or outliers. A gradient boosted tree model with monotonic constraints ensures model interpretability.

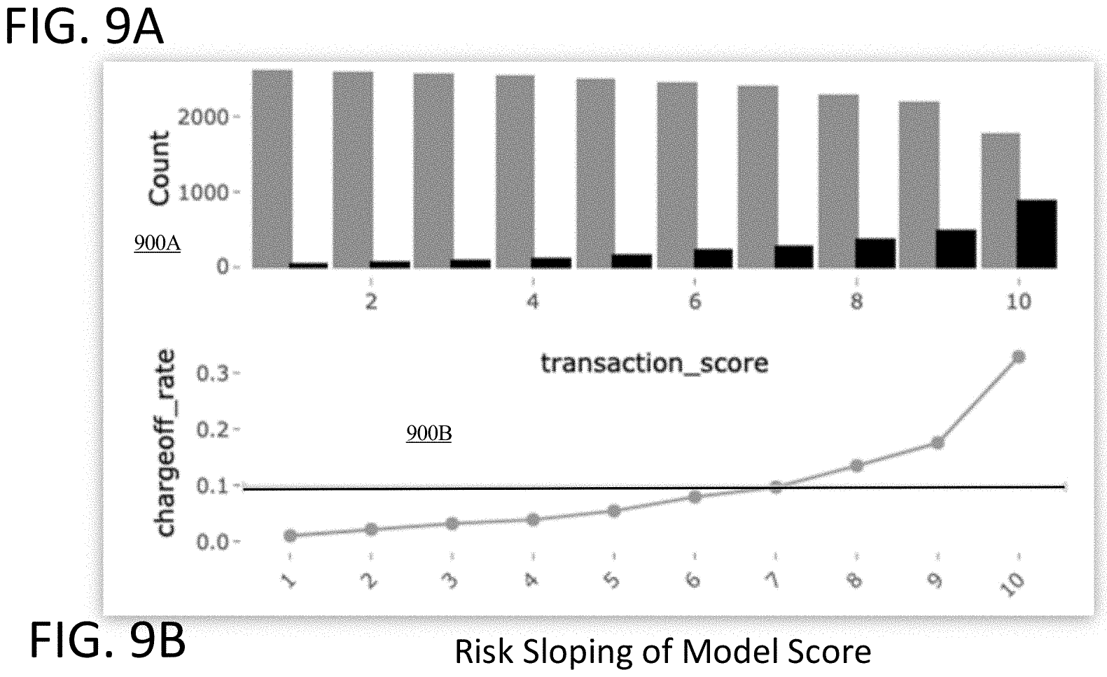

FIGS. 9A and 9B are example user interfaces of charts 900A,900B comparing cash transaction scores to charge-off rates. An administrator/user can use charts 900A,900B to build, inspect, update, and/or calibrate a transaction model. A transaction score is a financial metric that represents a charge-off probability (e.g., loan default probability). A transaction score model is a scheme for generating a transaction score for one or more consumers (borrowers). The overall goal of the model is to approve more applicants without increased risk for a lender.

The system analyzes transaction scores for a group of consumers (borrowers) who are performing transactions over a time period (e.g., 90 days, 60 days, 30 days, 15 days, or another other duration). The system executes a transaction model (e.g., gradient boosted tree model) by analyzing transactions in checking accounts of one thousand consumers for instance. Based on the tracked transactions, the system generates transaction scores for the one thousand consumers. In FIGS. 9A and 9B, the system calculates a transaction score for each borrower in a population of borrowers (e.g., 1,000 borrowers total). The system divides the borrowers into groups based on each borrower's transaction score. For example, the system divides the transaction scores into ten groups with about one hundred borrowers per group (e.g., one thousand borrowers total). The ten groups are along the x-axis in each chart 900A,900B. Consider group 1, in chart 900A for example. The left bar for group 1 indicates the total count of transactions within the group. The right bar for group 1 represents the transaction score for the consumers in group 1. The left and right bars in the other groups for chart 900A represent similar metrics but for different groups of consumers (loan applicants/borrowers).

Chart 900B shown in FIG. 9B illustrates how the charge-off rate (BAD Rate) increases (y axis) with the different consumer groups and their transaction. The charge-off rate or BAD rate, is the expected percentage of loan defaults in a population of borrowers in a loan portfolio. In a retrospective look at data, the charge-off rate is the actual percentage of defaults that occurred in a population of borrowers. For example, if Group 5 has $1,000,000 in loans and $70,000 in loans go into default, then the actual charge-off rate for Group 5 is 7% ($70,000/$1,000,000). The system can use the actual percentage of defaults (e.g., actual charge-off rate) to predict a future expected percentage of defaults (e.g., future expected charge-off rate). For example, if the system calculates the actual charge-off rate for Group 5 borrowers to be 7%, then the system may predict future borrowers with similar transactions to have a similar expected charge-off rate (along with a similar transaction score).

The right bars for each group in chart 900A shown in FIG. 9A also illustrates how the transaction score increases (y axis). The charts 900A,900B are user interfaces that enable inspection of the transaction score (e.g., happy money score) model (that uses a gradient boosted tree machine learning AI model) is working properly. Charts 900A,900B illustrate the importance of various selected feature data in the models generating the transactions score. The charts 900A,900B are showing that the transaction score is indeed sensitive to consumer behavior that the system is attempting to capture via analyzing the borrowers' financial transactions.

Chart 900B displays the charge-off rates for the groups. For example, Group 1 has the lowest transaction score and the lowest charge-off rate. Group 10 has the highest transaction score and the highest charge-off rate. The other groups are somewhere between Groups 1 and 10. The horizontal line in chart 900B is the average charge-off rate for all groups of borrowers combined in a loan portfolio. A low charge-off rate and a low transaction score are desirable (e.g., like a high FICO credit score is desirable in a traditional credit model). In contrast, a high charge-off rate and a high transaction score are undesirable (e.g., like a low FICO credit score is undesirable in a traditional credit model). An acceptable charge off rate can be indicated by a line, such as the line at 0.1 or representing a charge off rate of ten percent rate.

The financial (cash) transaction score, included as part of the happy money score, has a number of selected financial features associated with the borrower. A feature of interest may be referred to as a predictor. Example features include, without limitation, checking balance volatility (e.g., FIG. 10A), overdraft count (e.g., FIG. 11A), savings balance (e.g., FIG. 12A), number of income sources (e.g., FIG. 13A) spending/income ratio (e.g., FIG. 14A), and so on.

FIGS. 10A and 10B are example user interfaces of charts 1000A,1000B illustrating substantially the same concept as FIGS. 9A-9B, but with a specific feature (predictor) in the model. An administrator/user can use charts 1000A,1000B to build, inspect, update, and/or calibrate a transaction model. In FIGS. 10A-10B, the system is tracking volatility of checking account balances. Charts 1000A,1000B together illustrate that a higher checking balance volatility is associated with a higher charge-off rate. The charts 1000A,1000B are a verification that the transaction model is working properly. The charts 1000A,1000B are showing that the transaction score is indeed sensitive to consumer behavior that the system is attempting to capture via analyzing volatility of checking account balances.

The system computes the net balance across all checking accounts for each day. For each week, the system computes the mean balance. The system computes the coefficient of variation of that weekly balance (e.g., the standard deviation of the balances divided by the mean of the balances). The system applies capping and/or flooring to outlier values. The system divides the consumers into groups (e.g., five groups or any other size) based on checking balance volatility. Chart 1000A shows a calculation of checking balance volatility for five different groups of consumers. At Group 1, for example, the tall empty bar represents the number of non-charge-offs in Group 1, and the short solid bar represents the number of charge-offs in Group 1. The other groups have similar metrics. Group 1 is the checking balances with the least volatility. Group 5 is the checking account balances with the most volatility. Groups 2-4 have increasingly more volatility between Groups 1 and 5.

Chart 1000B shows the corresponding charge-off rate for each group. The horizontal line is the average charge-off rate (“pop rate” or population rate) for all the groups in the model. As the checking account volatility increases, the corresponding charge-off rate tends to increase as well. Group 1 has the lowest checking balance volatility and the lowest charge-off rate. Group 5 has the highest checking balance volatility and the highest charge-off rate. Groups 2-4 have increasingly more volatility and increasingly more charge-off rates, between Groups 1 and 5. Checking account volatility is one of many features (predictors) that the system can use in running a transaction model. Other example features (predictors) are discussed with reference to FIG. 8 among other places.

FIGS. 11A and 11B are example user interfaces of charts 1100A,1100B illustrating population counts (y axis-chart 1100A) and charge off rates (y axis-chart 1100B) for grouped ranges of the number of overdrafts per borrower (x axis). An administrator/user can use charts 1100A,1100B to build, inspect, update, and/or calibrate a transaction model. Group 1 borrowers have a range of 0 to 1.25 overdrafts. Group 2 borrowers have a range of 1.25 to 2.5 overdrafts. Group 3 borrowers have a range of 2.5 to 3.75 overdrafts. Group 4 borrowers have a range of 3.75 to 5 overdrafts. The left hollow bar for each group indicates the population count without charge off. The right solid bar for each group indicates the population count that had a charge off.

In chart 1100B, the horizontal line represents an average population of charge offs across the total population borrowers. The count of borrowers in group 1 without a charge off (left hollow bar) is high, nearly 20000. The count of borrowers in group 1 with a charge off (right solid bar) is higher than others, around 2000. However, the charge off rate for borrowers in Group 1 is below the average population rate line. As the overdraft count per borrower increases with Groups 2, 3, and 4, the charge off rate increases above the average population rate line as shown in chart 1100B of FIG. 11B. However, the count of borrowers in Groups 2, 3, and 4 are lower, as shown in chart 1100A of FIG. 11A, such that it the charge off is a less frequent occurrence.

FIGS. 12A and 12B are example user interfaces of charts 1200A,1200B illustrating substantially the same concept as FIGS. 9A-9B, but with a specific feature (predictor) in the model. An administrator/user can use charts 1200A,1200B to build, inspect, update, and/or calibrate a transaction model. In FIGS. 12A-12B, the system is tracking savings account balances. Charts 1200A,1200B together illustrate that a higher savings balance is associated with a lower charge-off rate. The charts 1200A,1200B are a verification that the transaction model is working properly. The charts 1200A,1200B are showing that the transaction score is indeed sensitive to consumer behavior that the system is attempting to capture via analyzing savings account balances. The horizontal line represents the average charge off rate of population (pop rate) as a whole.

The system computes the balance for all savings accounts. The system divides the consumers into groups (e.g., five groups or any other size) based on savings balance. Group 1 has a savings balance range from zero to 500 (e.g., $500). Group 2 has a savings balance range from 500 to 1,000. Group 3 has a savings range from 1,000 to 1,500. Group 4 has a savings range from 1,500 to 2,000. Group 5 has a savings range from 2,000 to 2,500.

Chart 1200A shows a calculation of savings balance for five different groups of consumers. At Group 1, for example, the tall empty bar represents the number of non-charge-offs in Group 1. The short solid bar represents the number of charge-offs in Group 1. The other groups have similar metrics. Group 1 has the lowest savings balances. Group 5 has the highest savings balances. Groups 2-4 having increasingly more savings between Groups 1 and 5.

Chart 1200B shows the corresponding charge-off rate for each group. The horizontal line is the average charge-off rate (“pop rate” or population rate) for all the groups. Group 1 has the lowest savings and the highest charge-off rate. Group 5 has the highest savings and nearly the lowest charge-off rate. As the saving balance increases, the corresponding charge-off rate tends to decrease, and vice versa.

However, with real-world data, the system may come across data that does not always fit the rule. For example, in the FIGS. 12A-12B, Group 4 may have an unexpected result and/or an anomaly (e.g., an abnormal value that is outside a statistically normal range). Specifically, Group 4 has a lower savings than Group 5 while having a lower charge-off rate (unexpected result and/or anomaly). Group 4 thereby defies the notion that a lower savings tends to be associated a higher charge-off rate. Accordingly, the system may discover that real world data does not always strictly follow a predetermined rule. Like in FIGS. 12A-12B, the system has discovered Group 4 with a lower savings while also has a lower charge-off rate, even though such a finding may not be typical. An anomaly in the data is a reason for the system to run a transaction model with many features (e.g., 2 or more predictors), so the system can weed out (e.g., average out) the anomaly from a transaction score. If there are significant unexpected results in the real-world data (e.g., more unexpected results than a predetermined threshold, more than one group has unexpected data, an anomaly far outside the statistical norm, or any other threshold, etc.), then the system can use the unexpected results to refine, update, and/or calibrate the transaction model. A savings account balance is one of many features (predictors) that the system can use in running a transaction model. Other example features (predictors) are discussed with reference to FIG. 8 among other places.

FIG. 13A-13B are example user interfaces of charts 1300A-1300B comparing default risk (e.g., charge-off risk) to a calculated number of income sources. An administrator/user can use charts 1300A,1300B to build, inspect, update, and/or calibrate a transaction model. Five groups of borrowers can be defined over the population of borrowers in a loan portfolio, Group 1 to Group 5. Borrowers in Group 1 have a range of zero to two sources of incomed calculated by the model. Borrowers in Group 2 have a range of two to four sources of incomed calculated by the model. Borrowers in Group 3 have a range of four to six sources of incomed calculated by the model. Borrowers in Group 4 have a range of six to eight sources of incomed calculated by the model. Borrowers in Group 5 have a range of eight to ten sources of incomed calculated by the model.

Chart 1300B indicates a charge off rate (bad rate) of about 0.10 or 10% for Group 1. Group 2 has the highest charge off rate of about 0.099 or 9%. Group 3 has a charge off rate of about 0.1 or 10%. Group 4 has a charge off rate of about 0.12 or 12%. Group 5 has a charge off rate of about 0.16 or 16%. The horizontal line in chart 1300B indicates the average population of borrowers in the loan portfolio has an average charge off rate of about 0.10 or 10% over all groups.

Chart 1300A illustrates the spread of the population of borrowers in the loan portfolio over the defined five groups of number of income sources (x axis) in relation to counts of default/no-default (y-axis). The count of default (y-axis) is the right bar for each group. The count of no-default (y-axis) is the left bar for each group.

Group 1 has the largest number of borrowers and the highest count of default. About 2000 borrowers in group 1 had a charge off or default. About 16,000 borrowers in Group 1 did not have a charge off or default. Accordingly, with some borrowers having no or one income source, the number of income sources is an indication of some risk of about 10% of default or charge-off. Group 2 with more than one income source has a lower default or charge off count of about 100 than Group 1, and a count of about 6000 with no charge off. Group 3 has a similar charge off percentage as Group 1 but with fewer borrowers. Groups 4 and 5 have greater charge off rates but with fewer borrowers defaulting. Borrowers in Groups 4 and 5 may have lower amounts of income for each income source of the multiple sources. Charts 1300A-1300B illustrate how useful the number of income sources to a borrower can be in predicting default and the happy money score.

FIGS. 14A-14B are example user interfaces of charts 1400A,1400B illustrating the spending-to-income ratios (spending divided by income). An administrator/user can use charts 1400A,1400B to build, inspect, update, and/or calibrate a transaction model. The system associates a ratio with each borrower of a plurality of borrowers in a portfolio of a plurality of similar loans (loan portfolio).

Five groups of borrowers can be defined over the population of borrowers in the loan portfolio, Group 1 to Group 5. Borrowers in Group 1 have a range of spending to income ratio of zero to 0.876. Borrowers in Group 2 have a range of spending to income ratio of 0.876 to 0.993. Borrowers in Group 3 have a range of spending to income ratio of 0.993 to 1.06. Borrowers in Group 4 have a range of spending to income ratio of 1.06 to 1.21. Borrowers in Group 5 have a range of spending to income ratio of 1.21 to 1.99.

Chart 1400B indicates a charge off rate (bad rate) of about 0.10 or 10% for Group 1. Group 2 has the highest charge off rate of about 0.099 or 9%. Group 3 has a charge off rate of about 0.1 or 10%. Group 4 has a charge off rate of about 0.12 or 12%. Group 5 has a charge off rate of about 0.16 or 16%. The horizontal line in chart 1300B indicates the average population of borrowers in the loan portfolio has an average charge off rate of about 0.10 or 10% over all groups.

Chart 1400A illustrates the spread of the population of borrowers in the loan portfolio over the defined five groups of spending to income ratios (x axis) in relation to counts of default/no-default (y-axis). The count of default (y-axis) is the right bar for each group. The count of no-default (y-axis) is the left bar for each group.

Each Group had near equal counts of borrowers that had a charge-off/default (500 count) and no charge-off/default (5000). Groups 1 through 4 have a charge-off rate below the average population rate. Group 4 has the lowest charge off rate. Group 5 has the largest charge-off rate around 0.125 or 12.5%. As the spending to income ratio goes above 1.21, the charge off rate/default increases above the average population rate. Charts 1400A-1400B illustrate how useful the spending to income ratio associated with a borrower can be in predicting default and the happy money score.

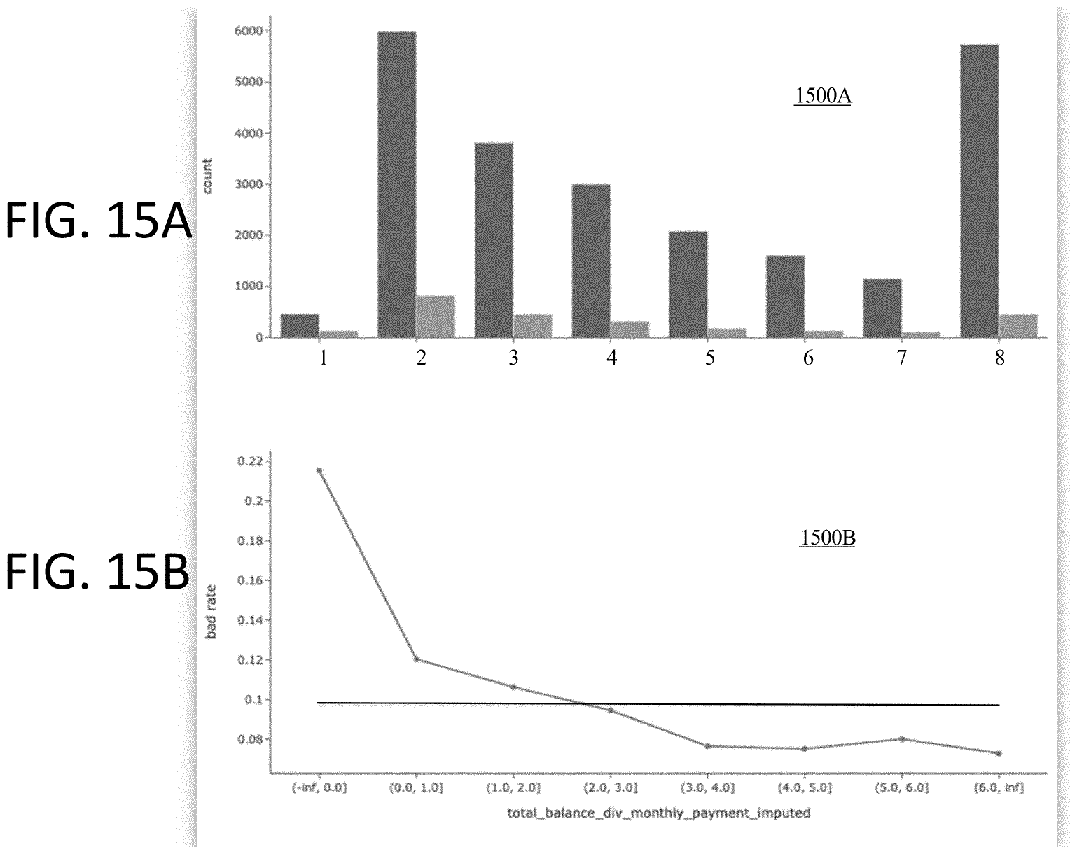

FIGS. 15A and 15B are user interfaces of charts 1500A,1500B illustrating the ratio of total cash balances divided by the monthly payment that would be made on a desired loan (loan amount and term). An administrator/user can use charts 1500A,1500B to build, inspect, update, and/or calibrate a transaction model. The total cash to monthly payment ratio represents the number of payments a borrower could make on the loan, if the borrower no longer had a source of income.

Eight groups of borrowers can be defined over the population of borrowers in the loan portfolio, Group 1 to Group 8. Borrowers in Group 1 have a range of total cash to monthly payment ratio of a negative larger number (infinity) to zero. One would expect a borrower with no cash savings to make any monthly payment to have a high charge off rate. Borrowers in Group 2 have a range of total cash to monthly payment ratio of zero to 1.0. Borrowers in Group 3 have a range of total cash to monthly payment ratio of 1.0 to 2.0. Borrowers in Group 4 have a range of total cash to monthly payment ratio of 2.0 to 3.0. Borrowers in Group 5 have a range of total cash to monthly payment ratio of 3.0 to 4.0. Borrowers in Group 6 have a range of total cash to monthly payment ratio of 4.0 to 5.0. Borrowers in Group 7 have a range of total cash to monthly payment ratio of 5.0 to 6.0. Borrowers in Group 8 have a range of total cash to monthly payment ratio of 6.0 to a large number such as 9999 or infinity.

The horizontal line shown in chart 1500B of FIG. 15B indicates an average population charge off rate of about 0.1 or 10% for the population as a whole in a loan portfolio. Group 1 has the highest charge off rate (bad rate) of about 0.22 or 22%. Group 2 has a charge off rate of about 0.12 or 12%. Group 3 has a charge off rate of about 0.11 or 11%. Group 4 has a charge off rate just below the population charge off rate of about 0.099 or 9.9%. Group 5 has a charge off rate of about 0.08 or 8%. Group 6 has a charge off rate of about 0.078 or 7.8%. Group 7 has a charge off rate of about 0.082 or 8,2%. Group 8 has a charge off rate of about 0.07 or 7%.

Chart 1500A illustrates the spread of the population of borrowers in the loan portfolio over the defined eight groups of total cash to monthly payment ratio (x axis) in relation to counts of default/no-default (y-axis). The count of default (y-axis) is the right bar for each group. The count of no-default (y-axis) is the left bar for each group.

In chart 1500B, groups 1 through 3 had a charge-off rate above the average population rate (the horizontal line). The horizontal line represents an average charge-off rate of about 0.1 or 10%. Group 1 with the highest charge off rate has the fewest borrowers. Presumably an applicant borrower without any cash savings would not bother to seek a loan. Regardless, about 100 borrowers in Group 1 had a charge off, while about 500 borrowers in Group 1 did not. Group 2 had greatest number of total borrowers. Group 2 also had the greatest number (about 800 count) of borrowers with a charge off. There were about 6000 borrowers in Group 2 that had not charge off or default. Group 3 had about 500 borrowers with a charge off and about 3700 borrowers with no charge off. Groups 4 through 8, with cash accounts totaling to more than two monthly payments, have a charge-off rate below the average population rate. Group 4 has the lowest charge off rate. Group 4 has about 300 borrowers with a charge off and about 3000 borrowers without. Group 5 has about 150 borrowers with a charge-off and about 2000 borrowers that did not. Group 6 has about 100 borrowers with a charge off and about 1500 borrowers without a charge off. Group 7 has about 50 borrowers with a charge off and 1100 without. Group 8, a large group of borrowers, has about 500 borrowers with a charge off and about 5500 borrowers without. Groups 1 through 3 had a charge-off rate above the average population rate (the horizontal line). Group 1 with the highest charge off rate has the fewest borrowers. Presumably an applicant borrower without any cash savings would not bother to seek a loan. Regardless, about 100 borrowers in Group 1 had a charge off, while about 500 borrowers in Group 1 did not. Group 2 had greatest number of total borrowers. Group 2 also had the greatest number (about 800 count) of borrowers with a charge off. There were about 6000 borrowers in Group 2 that had not charge off or default. Group 3 had about 500 borrowers with a charge off and about 3700 borrowers with no charge off. Groups 4 through 8, with cash accounts totaling to more than two monthly payments, have a charge-off rate below the average population rate. Group 4 has the lowest charge off rate. Group 4 has about 300 borrowers with a charge off and about 3000 borrowers without. Group 5 has about 150 borrowers with a charge-off and about 2000 borrowers that did not. Group 6 has about 100 borrowers with a charge off and about 1500 borrowers without a charge off. Group 7 has about 50 borrowers with a charge off and 1100 without. Group 8, a large group of borrowers, has about 500 borrowers with a charge off and about 5500 borrowers without. Groups 1 through 3 had a charge-off rate above the average population rate (the horizontal line). Group 1 with the highest charge off rate has the fewest borrowers. Presumably an applicant borrower without any cash savings would not bother to seek a loan. Regardless, about 100 borrowers in Group 1 had a charge off, while about 500 borrowers in Group 1 did not. Group 2 had greatest number of total borrowers. Group 2 also had the greatest number (about 800 count) of borrowers with a charge off. There were about 6000 borrowers in Group 2 that had not charge off or default. Group 3 had about 500 borrowers with a charge off and about 3700 borrowers with no charge off. Groups 4 through 8, with cash accounts totaling to more than two monthly payments, have a charge-off rate below the average population rate. Group 4 has the lowest charge off rate. Group 4 has about 300 borrowers with a charge off and about 3000 borrowers without. Group 5 has about 150 borrowers with a charge-off and about 2000 borrowers that did not. Group 6 has about 100 borrowers with a charge off and about 1500 borrowers without a charge off. Group 7 has about 50 borrowers with a charge off and 1100 without. Group 8, a large group of borrowers, has about 500 borrowers with a charge off and about 5500 borrowers without.

Charts 1500A,1500B illustrate how useful the total cash to monthly payment ratio, associated with a borrower, can be in predicting default and the happy money score.

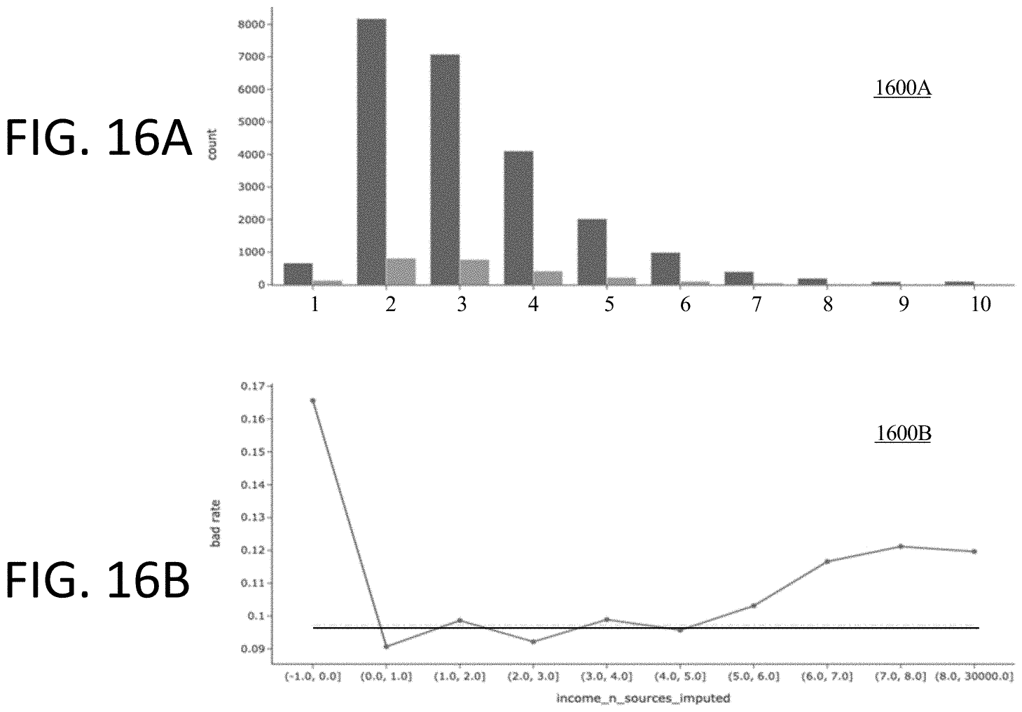

FIGS. 16A and 16B are user interfaces of charts 1600A,1600B illustrating the number of borrowers associated with a range of income sources. An administrator/user can use charts 1600A,1600B to build, inspect, update, and/or calibrate a transaction model. Ten groups of borrowers Group 1 to Group 10 are defined. Borrowers in Group 1 have a range of number of income sources from negative one to zero. Borrowers in Group 2 have a range of number of income sources from zero to one. Borrowers in Group 3 have a range of number of income sources from one to two. Borrow Borrowers in Group 4 have a range of number of income sources from two to three. Borrowers in Group 5 have a range of number of income sources from negative three to four. Borrowers in Group 6 have a range of number of income sources from four to five. Borrowers in Group 7 have a range of number of income sources from five to six. Borrowers in Group 8 have a range of number of income sources from six to seven. Borrowers in Group 9 have a range of number of income sources from seven to eight. Borrowers in Group 10 have a range of number of income sources from eight to a large number such as 30000.

Chart 1600A illustrate the number (count) of borrowers in each group of the ten groups for the loan portfolio (group of loans of borrowers). The right bar in the group illustrates the number (count) of borrowers within the group that default. The left bar in the group illustrates the number (count) of borrowers within the group that do not default. Because a larger number of income sources can be beneficial, the count of borrowers within each group that do not default is greater than the count of borrowers within each group that do default.

Chart 1600B illustrates the charge off rate (bad rate) (y axis) based on the groupings of the numeric range of income sources imputed to the borrower (x axis). The horizontal line indicates an average charge-off rate of about 0.098 or 9.8%. From group 2 to group 6, the charge off rate seems to decrease or be steady state. Groups 7 to groups 10, the charge off rate tends to increase, probably due to false assertions of income. If a borrower falls into Group 1, with no source of income, the charge off rate is significantly great between 0.16 and 0.17 or sixteen to seventeen percent. Charts 1600A-1600B illustrate how useful the number of income sources imputed (associated) to a borrower can be in predicting default and the happy money score.

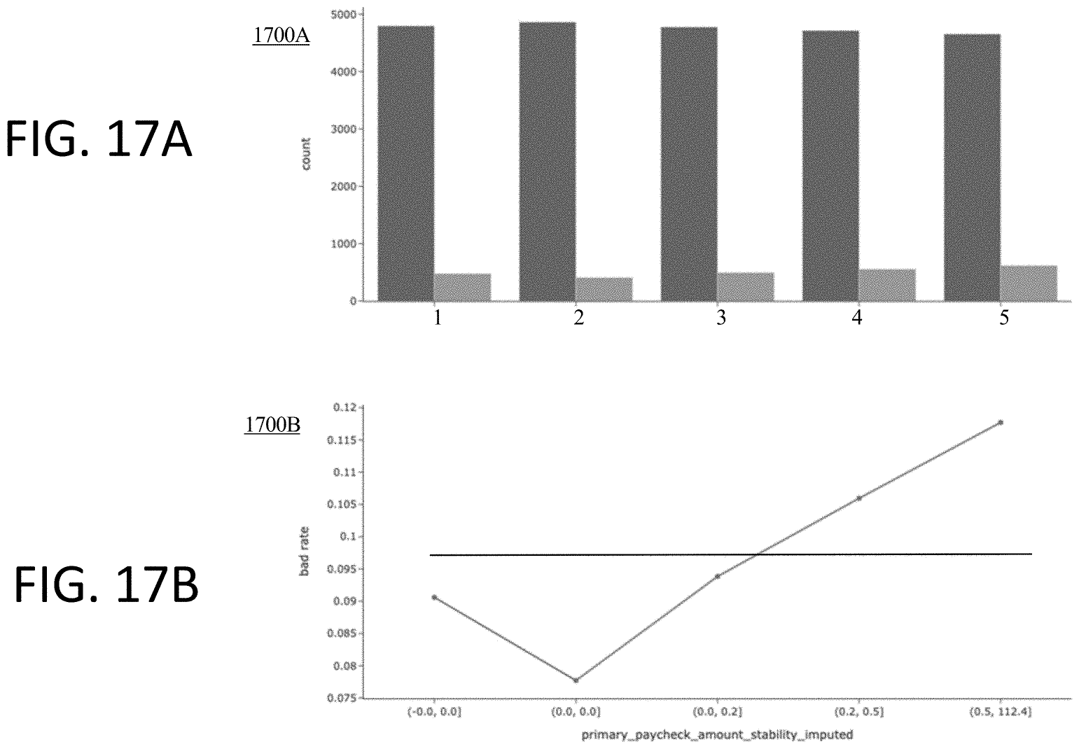

FIGS. 17A and 17B are user interfaces of charts 1700A,1700B illustrating the stability (or instability) of the primary paycheck amount associated with a borrower over two or more pay periods of time. An administrator/user can use charts 1700A,1700B to build, inspect, update, and/or calibrate a transaction model. Five groups of borrowers Group 1 to Group 5 are defined over two or more pay periods of time. Borrowers in Group 1 have a negative stability (instability) amount (paycheck decreases) to zero stability. Borrowers in Group 2 have a change in stability of zero over two or more pay periods of time, representing a constant paycheck. Borrowers in Group 3 have a range in change of stability from zero to 0.2 or 20% in the paycheck amount. Borrowers in Group 4 have a range in change of stability from 0.2 or 20% to 0.5 or 50% in the paycheck amount. Borrowers in Group 5 have a range in change of stability from 0.5 or 50% to 112.4 or more than 100% in the paycheck amount.

Chart 1700A illustrate the number (count) of borrowers in each group of the five groups for the loan portfolio (group of loans of borrowers). The right bar in the group illustrates the number (count) of borrowers within the group that default. The left bar in the group illustrates the number (count) of borrowers within the group that do not default. The left bar and right bar for each group remains about the same over the different groups for paycheck amount instability/stability.

Chart 1700B illustrates the charge off rate (bad rate) (y axis) based on the groupings of the range of paycheck amount stability/instability imputed to the borrowers (x axis). The horizontal line indicates an average charge-off rate of about 0.0975 or 9.75%. For Group 1, the charge off rate is approximately 0.09 or 9%. For Group 2, the most stable group of paycheck income, the charge off rate is lowest at approximately 0.078 or 7.8%. In group 3, the charge off rate is 0.095 or 9.5%. In group 4, the charge off rate is 0.105 or 10.5%. In group 5, the charge off rate is 0.12 or 12%. Change in the paycheck income of a borrower is detrimental. Stability in the paycheck income is desirable. The charge off rate increases from group 2 to group 5 as the paycheck income becomes less stable. Charts 1700A-1700B illustrate how useful the paycheck income stability imputed (associated) to a borrower can be in predicting default and the happy money score.

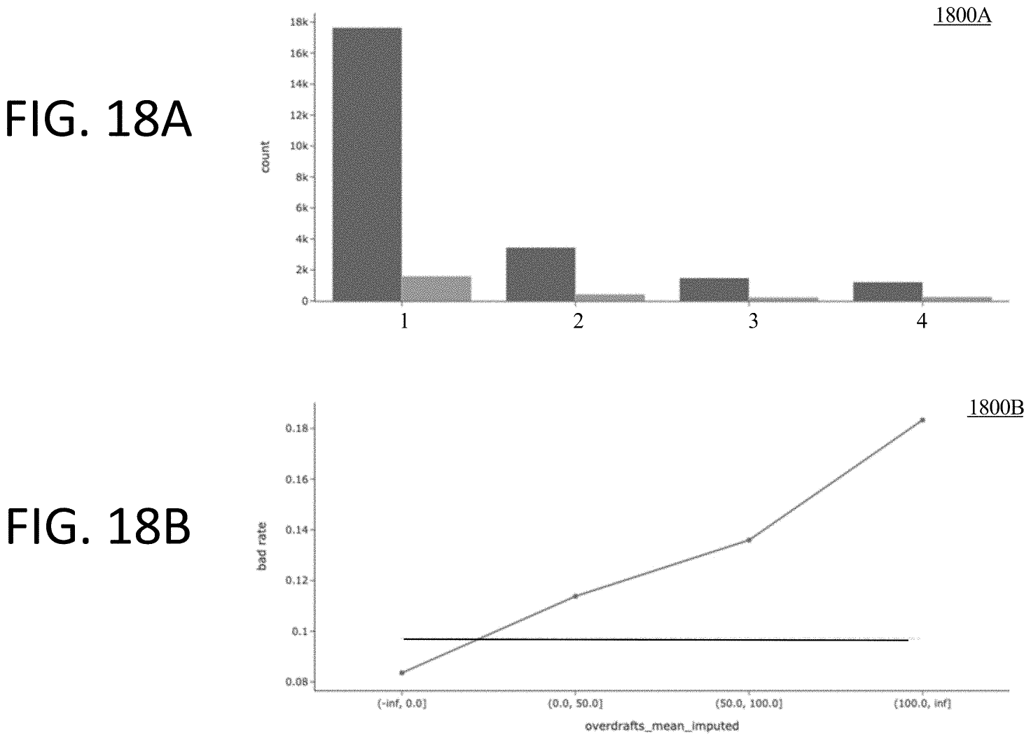

FIGS. 18A and 18B are user interfaces of charts 1800A,1800B illustrating the mean or average overdraft amount of the checking account associated with a borrower. An administrator/user can use charts 1800A,1800B to build, inspect, update, and/or calibrate a transaction model. Fours groups of borrowers can be defined, Group 1 to Group 4. Borrowers in Group 1 have no amount of overdraft. Borrowers in Group 2 have a range of average overdraft amount from zero to 50. Borrowers in Group 3 have a range of average overdraft amount from 50 to 100. Borrowers in Group 4 have a range of average overdraft amount from 100 to a large number such as positive infinity.

Chart 1800A illustrates the number (count) of borrowers in each group of the four groups for the loan portfolio (group of loans of borrowers). The right bar in the group illustrates the number (count) of borrowers within the group that default. The left bar in the group illustrates the number (count) of borrowers within the group that do not default. In group 1, it is expected that few borrowers default. Indeed, the left non-default bar in group 1 is about 18 k in count while the right default bar is about 1.5 k count.

Chart 1800B illustrates the charge off rate (bad rate) (y axis) based on the groupings of the ranges of overdraft imputed to the borrowers (x axis). The horizontal line indicates an average charge-off rate of about 0.1 or 10%. For Group 1, the lowest charge off rate is approximately 0.09 or 9%. For Group 2, the charge off rate is lowest at approximately 0.115 or 11.5%. In group 3, the charge off rate is about 0.235 or 13.5%. In group 4, the charge off rate is 0.18 or 18%. The trend of increased amounts of overdraft of a checking account leads to greater of charge off rates. The charge off rate increases from group 1 to group 4 as the mean amount of overdraft increases. Charts 1800A-1800B illustrate how useful the mean amount of overdraft over periods of time imputed (associated) to a borrower can be in predicting default and the happy money score.

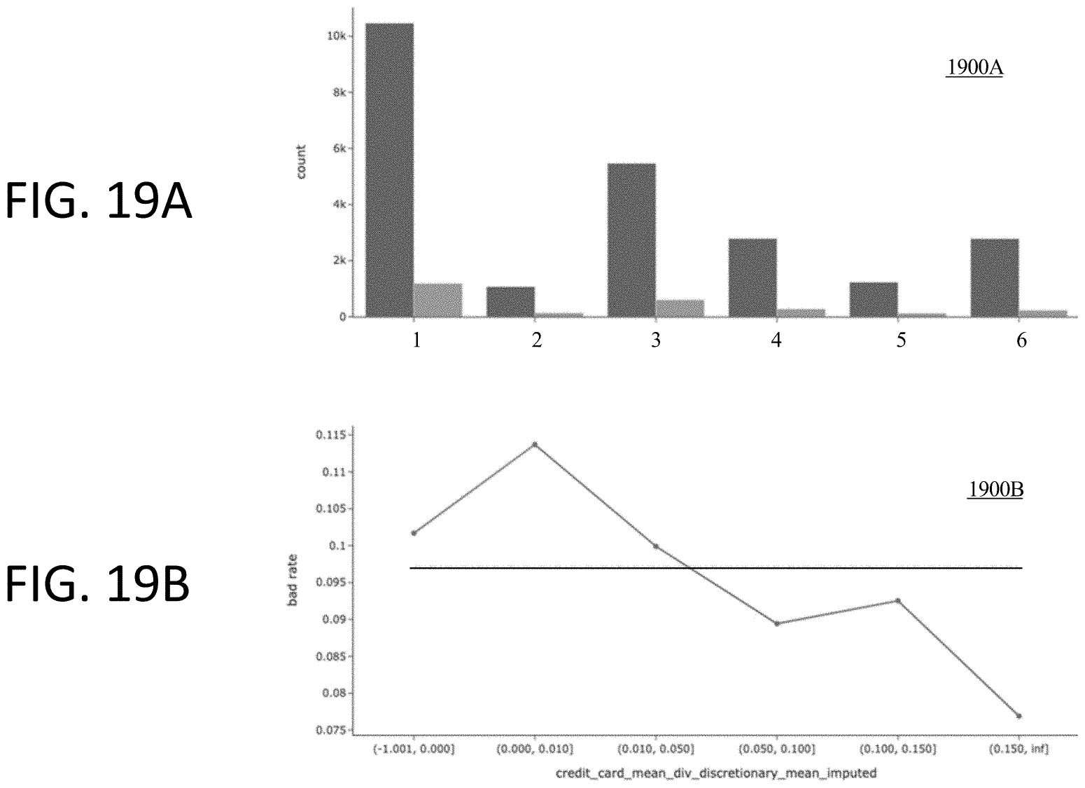

FIGS. 19A and 19B are user interfaces of charts 1900A,1900B illustrating a ratio of the mean or average credit card balance over (divided by) the average or mean discretionary spending (credit card debt to discretionary spending or income) associated with a borrower. An administrator/user can use charts 1900A,1900B to build, inspect, update, and/or calibrate a transaction model. Six groups of borrowers can be defined, Group 1 to Group 6.

Borrowers in Group 1 have no credit card debt such that the credit card debt to spending ratio is zero. Borrowers in Group 2 have a range of credit card debt to spending ratio from zero to 0.010. Borrowers in Group 3 have a range of credit card debt to spending ratio from 0.010 to 0.050. Borrowers in Group 4 have a range of credit card debt to spending ratio from 0.050 to 0.100. Borrowers in Group 5 have a range of credit card debt to spending ratio from 0.100 to 0.150. Borrowers in Group 6 have a range of credit card debt to spending ratio from 0.150 to a large value, such as 0.999 or infinity (inf).

Chart 1900B indicates a charge off rate (bad rate) of about 0.1 or 10% for Group 1. Group 2 has the highest charge off rate of about 0.13 or 13%. Group 2 has a charge off rate of about 0.13 or 13%. Group 3 has a charge off rate of about 0.1 or 10%. Group 4 has a charge off rate of about 0.09 or 9%. Group 5 has a charge off rate of about 0.092 or 9.2%. Group 6 has the lowest charge off rate of about 0.072 or 7.2%. The dashed line in chart 1900B indicates the average population has an average charge off rate of 0.097 or 9.7% over all groups.

Chart 1900A illustrates the spread of the population of borrowers in the loan portfolio over the defined six groups of credit card debt to spending ratio (x axis) in relation to counts of default/no-default (y-axis). The count of default (y-axis) is the right bar for each group. The count of no-default (y-axis) is the left bar for each group. Group 1 has the largest number of borrowers and has the highest count of default. About 1000 borrowers in group 1 had a charge off or default. About 10,000 borrowers in Group 1 did not have a charge off or default. As shown in chart 1900B, with some borrowers in Group 1, the lack of credit card debt is an indication of some risk of about 10% of default or charge-off. The horizontal line indicates an average charge-off rate of about 0.097 or about 97%. Group 2 with the highest risk of default, has a default or charge off count of about 20 and a count of about 900 with no charge off. If a borrower falls into Group 2, there is a higher probability of default than the other five groups. The probability of default shown by chart 1900B in FIG. 19B decreases as the borrowers have a greater credit card debt to spending ratio. This may indicate a better capability of paying off credit card debt with a larger ratio. Generally, Charts 1900A-1900B illustrate how useful the credit card debt to spending ratio imputed (associated) to a borrower can be in predicting default and the happy money score.

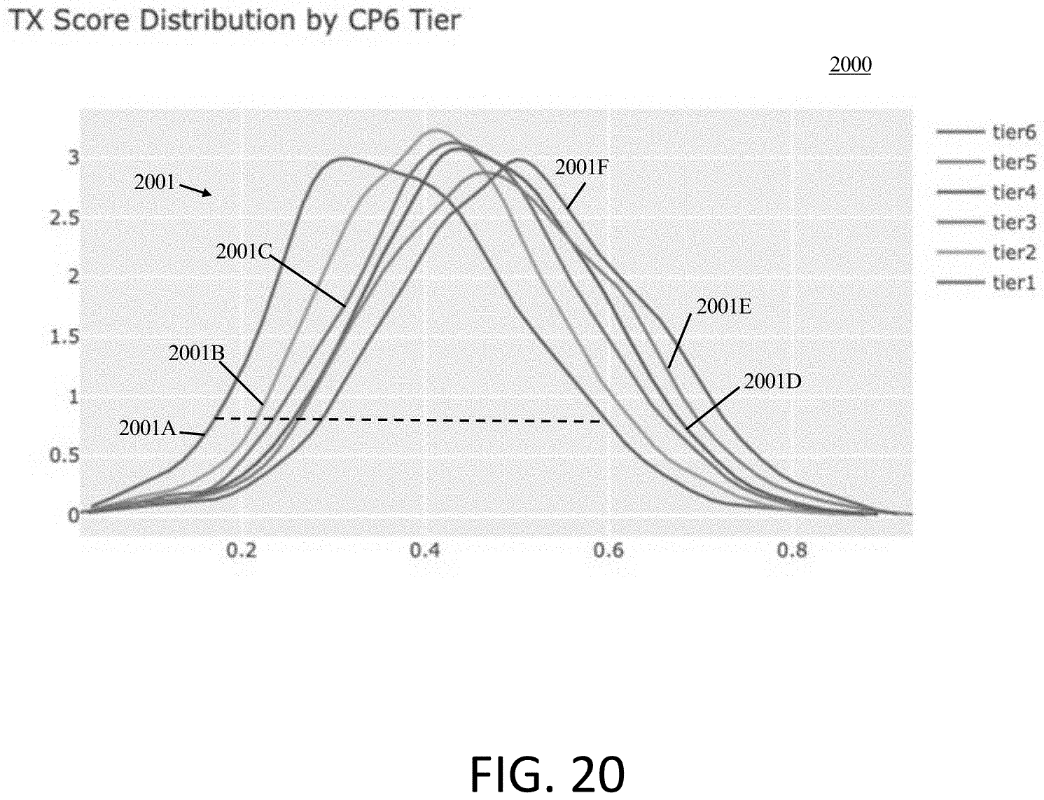

FIG. 20 is user interface of a chart 2000 illustrating plots of financial transaction score distributions (probability of default-X axis—the transaction score from 0 to 1) for six different tiers of borrowers represented by the different curves 201 in a loan portfolio. An administrator/user can use chart 2000 to build, inspect, update, and/or calibrate a transaction model. The x-axis represents the financial transaction score from 0 to 1, the probability of default of a borrower. At the boundary, a financial transaction score of 0 represents no likelihood of default of a borrower. A financial transaction score of 1 represents a certainty of default/charge-off of a borrower. The y-axis represents a magnitude of the number of borrowers in the loan portfolio (e.g., 0 to 3.5K with the given financial (cash) transaction score.

Borrowers can be grouped into tiers (quality of borrowers) by the system based on their income, their credit bureau scores and their verified data in their loan application to speed up the loan application process. Tier 1 borrowers, the highest quality of borrowers, can have a more simplified verification process and can get improved more quickly by the system. are represented by curve 2001A. Tier 6 borrowers, the lowest quality of borrowers in the loan portfolio, can have a more complex verification process, that provides a more accurate evaluation by the system. Tier 2 through Tier 5 are borrowers with a measure of quality between borrowers in Tier 1 and Tier 6.

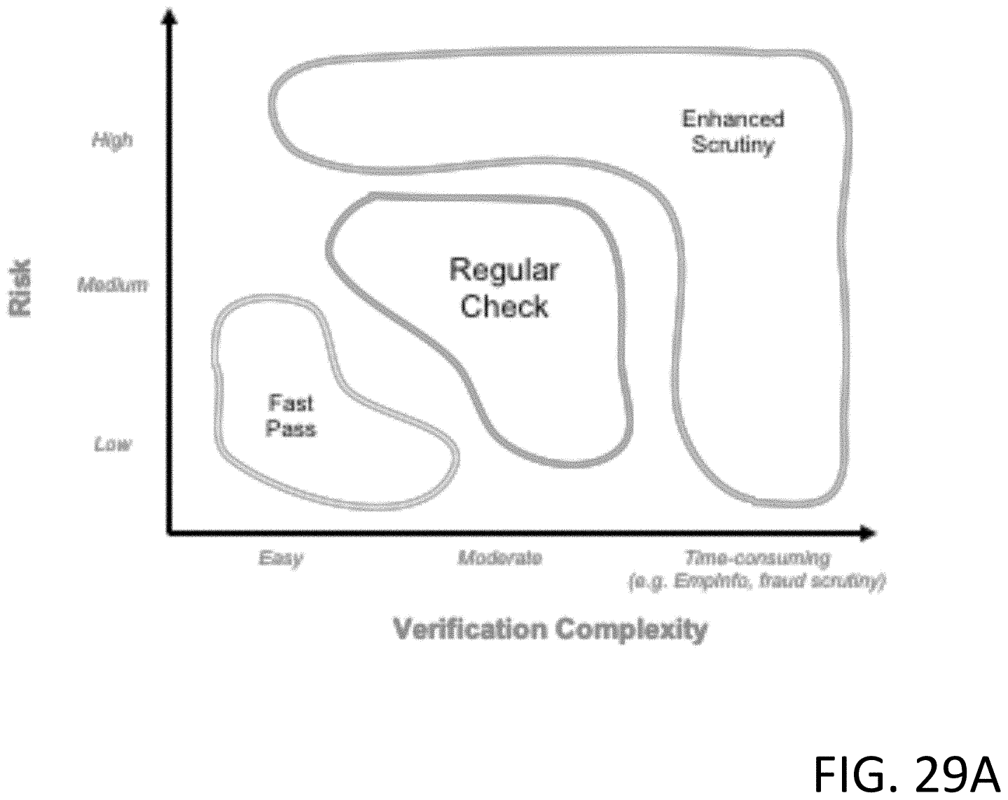

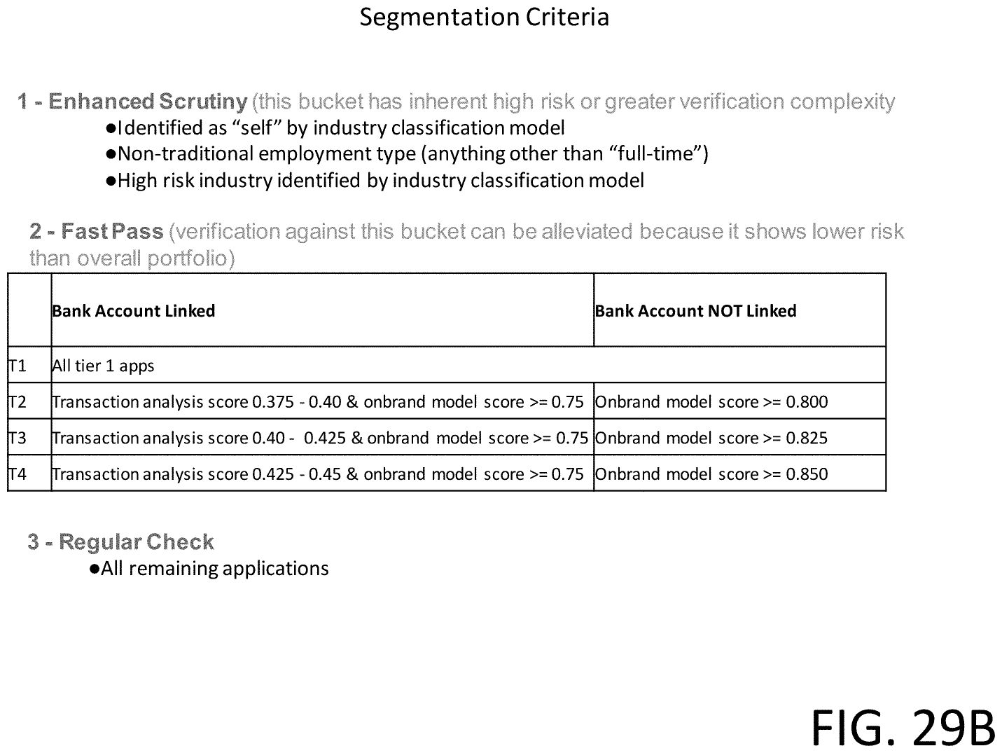

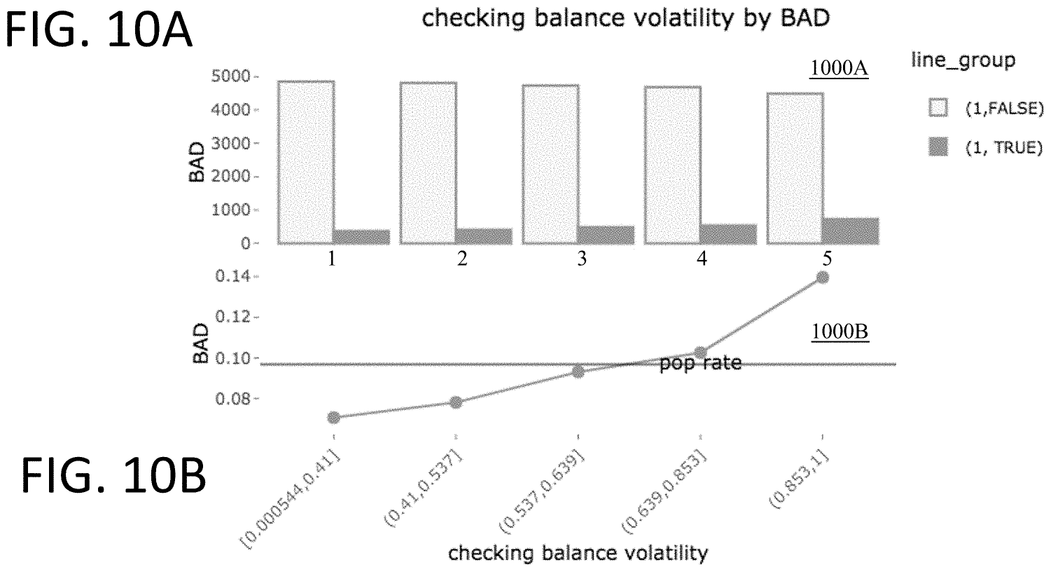

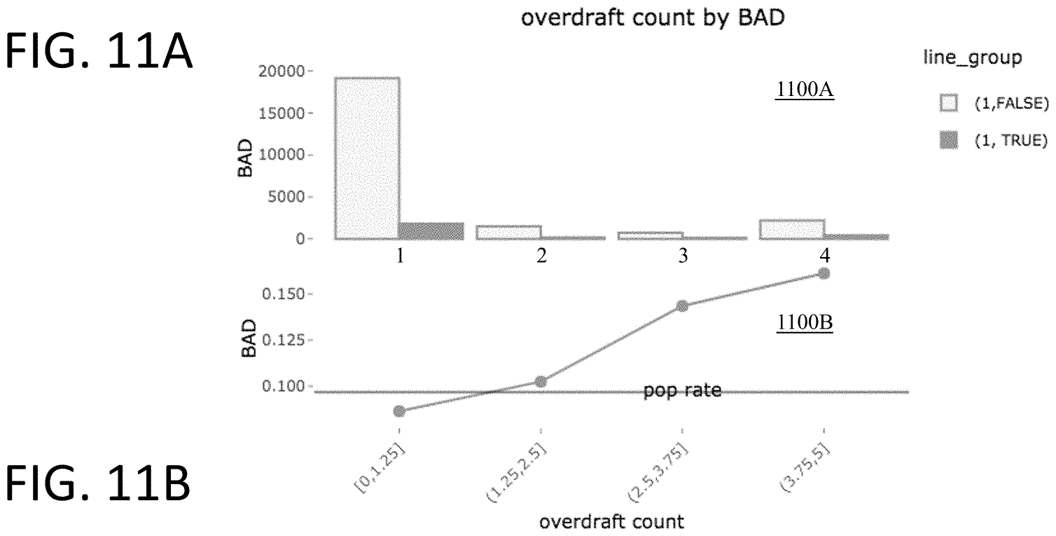

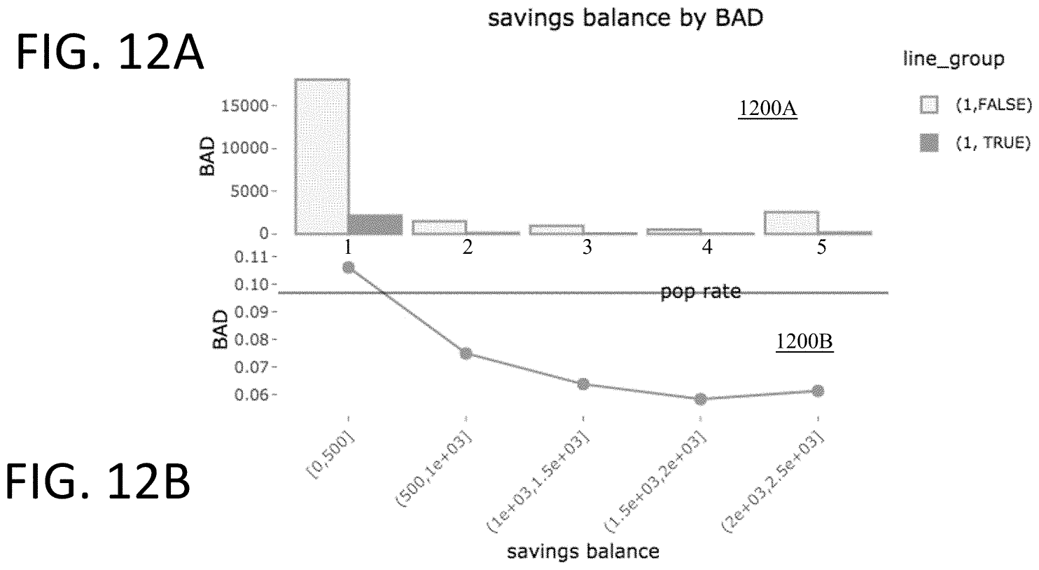

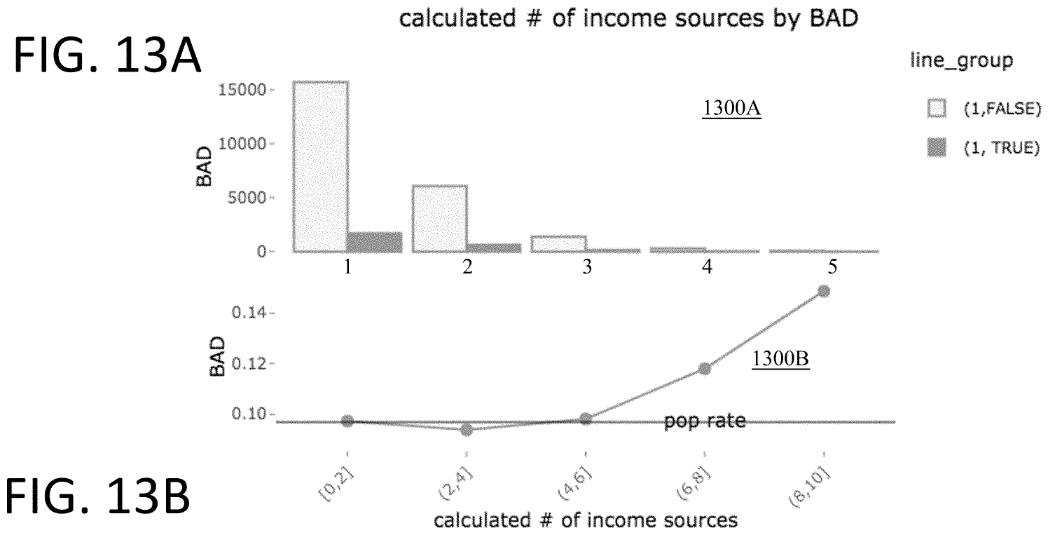

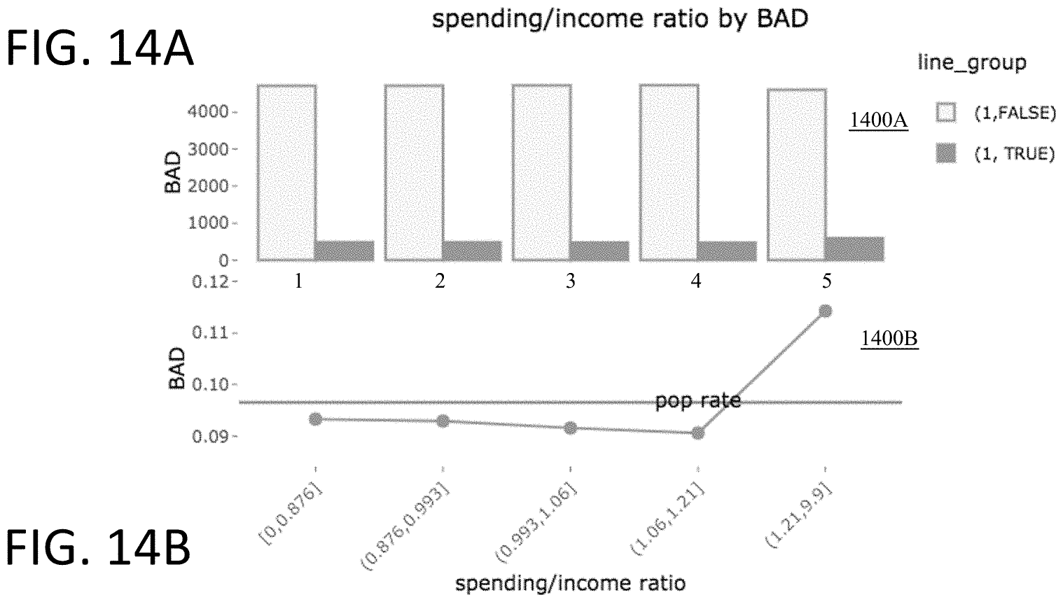

Referring to FIGS. 29A-29B, the income verifier can also segment borrower applicants to undergo slightly different risk analysis and manual/automated verifications based on the loan application and access to cash flow information. On an initial review of the loan application, the borrower may be determined to be lower risk and can undergo an easier verification process as indicated by a fast pass grouping of borrowers. Alternatively, the borrower may be determined upon initial review to be of higher risk and thus be subject to a higher time-consuming verification process as indicated by the enhanced scrutiny of borrowers. For those borrowers upon initial review that fall in between fast pass group and the enhanced scrutiny group, they are in a regular check group having a medium risk and a moderate verification.

If the borrower applicant is identified as self employed by an industry classification model, the applicant can be placed in the enhanced scrutiny group. If the borrower applicant is in a non-traditional employment type, (e.g., part-time or anything else other than full-time employment), the applicant can be placed in the enhanced scrutiny group. If the applicant is in a high-risk industry as identified by the industry classification model, the applicant be placed in the enhanced scrutiny group.

The borrower applicant that is the fast pass group can be further segmented into a plurality of tiers of borrowers based on the transaction analysis score and the on-brand (credit) bureau score if a bank account is linked for access and only the on-brand (credit) bureau score. If no bank account is linked, a borrower with an on-brand model score greater than or equal to 0.850 can be assigned to tier 4. With no linked bank account, a borrower with an on-brand model score between 0.825 and 0.850 can be assigned to tier 3. With no linked bank account, a borrower with an on-brand model score between 0.800 and 0.825 can be assigned to tier 2. Borrowers in the fast pass group without a linked bank account but better on-brand model scores below 0.800 can be assigned to tier 1, for example. If a bank account is linked, the transaction analysis score and the on-brand model score are used to assign a fast pass borrower into one of the plurality of tiers. For example, if the transaction analysis score is between 0.425 and 0.45 and the on-brand model score is greater than or equal to 0.75, the borrower applicant can be placed in tier 4. If the transaction analysis score is between 0.40 and 0.425 and the on-brand model score is greater than or equal to 0.75, the borrower applicant can be placed in tier 3. If the transaction analysis score is between 0.375 and 0.40 and the on-brand model score is greater than or equal to 0.75, the borrower applicant can be placed in tier 2. If the transaction analysis score is less than 0.375 and the on-brand model score is greater than or equal to 0.75, the borrower applicant can be placed in tier 1. The segmentation can be used to determine interest rates and loan amounts for the borrower.

Tier 1 borrowers, the highest quality of borrowers in the loan portfolio, are represented by distribution curve 2001A in chart 2000. Tier 2 borrowers in the loan portfolio are represented by distribution curve 2001B. Tier 3 borrowers in the loan portfolio are represented by distribution curve 2001C. Tier 4 borrowers in the loan portfolio are represented by distribution curve 2001D. Tier 5 borrowers in the loan portfolio are represented by distribution curve 2001E. Tier 6 borrowers, the lowest quality of borrowers in the loan portfolio, are represented by distribution curve 2001F in chart 2000.

The curves 2001 are not perfect normal distributions but are shaped somewhat similar to a bell curve such that statistical observations can be made. The transaction scores (x-axis) increase at the peaks (y-axis) of each curve/tier as the tier number increases. For example, the transaction score at the peak (about 3) of tier 1 curve 2001A corresponds to a financial transaction score of about 0.3. The transaction score at the peak (about 3.25) of tier 2 borrowers represented by curve 2001B corresponds to a financial transaction score of about 0.41. The transaction score at the peak (about 3.25) of tier 3 borrowers represented by curve 2001C corresponds to a financial transaction score of about 0.425. The transaction score at the peak (3.1) of tier 4 borrowers represented by curve 2001D corresponds to a financial transaction score of about 0.43. The financial transaction score at the peak (2.8) of tier 5 borrowers represented by curve 2001E corresponds to a financial transaction score of about 0.47. The financial transaction score at the peak (3) of tier 6 borrowers represented by curve 2001F corresponds to a financial transaction score of about 0.5.

A statistical model of curves 2001 for the various tiers can be used to determine the financial transaction scores that are acceptable for each tier of borrower. For example, if 95% of the borrowers in tier 1 would be acceptable, two standard deviations greater than the mean (represented by a horizontal line) can be chosen as the maximum transaction score on the curve for tier 1 borrowers. The 95% horizontal line intersects the value of about 0.6 for a transaction score for tier 1 borrowers. However, other factors can be considered, such as debt and credit bureau data (credit policies), along with the financial or cash transactions score.

The system is flexible. The system can use credit policies alone, financial transactions data alone, or it can fuse transaction data and credit policy data together to better predict a probability of default of a borrower. In one embodiment, the financial transactions data is used alone to evaluate a borrower without any credit score data being available. In another embodiment, the financial transactions data is fused together with credit policy data. In either case, a better prediction of default can be found. With a better prediction of default, loans can be originated to more borrowers overusing credit policies alone.

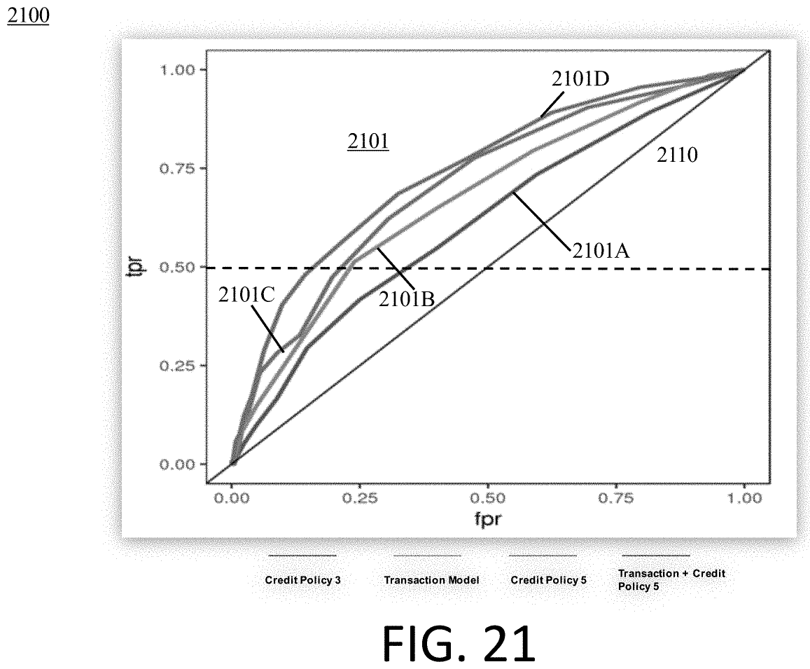

FIG. 21 is a user interface of chart 2100 illustrating receiver operating characteristics (ROC) curves 2101 for measuring model performance. An administrator/user can use chart 2100 to build, inspect, update, and/or calibrate a transaction model. The curves 2101 measure tpr (true positive rate) on the vertical (y) axis and fpr (false positive rate) on the horizontal (x) axis. A curve represents how good a model is at detecting charge-offs without making too many false positives. A charge-off is a debt that is deemed unlikely to be collected by the creditor, but the debt is not necessarily forgiven or written off entirely. A true positive means the system detected a charge-off when there was a charge-off. A false positive means the system detected a charge-off when there was not a charge-off.

The system can use a powerful combination of a financial transaction model and a typical credit model (e.g., analysis performed by a credit bureau) together to form an integrated financial transaction-credit model to generate a happy money score. Alternatively, the system can use a financial transaction-only model to determine probability of default and the happy money score, which still outperforms a typical credit-only model.

In the chart 2100, the curves 2101 include a Credit Policy 3 (first credit-only model) 2101A, a Transaction Model (transaction-only model) 2101B, Credit Policy 5 (second credit-only model) 2101C, and a Transaction plus Credit Policy 5 model (combination of transaction model and credit model) 2101D. The straight diagonal line 2110 represents a pure chance model, such as by flipping a coin multiple times getting 50% heads (true) and 50% tails (false). The more a curve 2101 veers toward the upper left corner, the more reliable the model is for detecting charge-offs without making unwanted false positives.

As shown by curve 2101D, the combined model of transaction model and credit model is substantially more reliable for detecting charge-offs compared to a typical credit-only model (e.g., analysis performed by a credit bureau) illustrated by curve 2101A. For example, if the system uses Transaction+Credit Policy 5 (combination model) and the true positive rate is desired to be 0.50 (or 50%) indicated by the dashed horizontal line, then the system can expect to receive a false positive rate of about 0.15 (or 15%), indicated by an imaginary vertical line drawn from the intersection point of the curve and dashed line down to the x-axis. In contrast, if the system uses Credit Policy 3 (credit-only model) illustrated by curve 2101A and the true positive rate is desired to be 0.50 (or 50%), then the system can expect to receive a false positive rate of about 0.35 (or 35%). If the system uses a pure chance model, represented by line 2110, and the true positive rate is desired to be 0.50 (or 50%), then the system can expect to receive a false positive rate of about 0.50 (or 50%). In an ideal situation, the system runs a perfect model, where the true positive rate is 100% and the false positive rate is 0%, but this is not possible.

To decide the point on a receiver operating characteristic (ROC) curve to operate, the system balances between reducing charge-offs (an acceptable risk) and an acceptable amount of money lost. That is, a goal of the system is to limit the false positive rate while increasing the true positive rate. A transaction model is typically more reliable than a typical credit bureau model, and a combination model is typically more reliable than a transaction model to better balance the system and lend money to more borrowers.

To construct a transaction model, the system may calculate tens or hundreds of features related to transactions, wealth, and/or credit, etc. The system calculates features from raw transaction streams by one or more consumers. For example, a transaction model may include without limitation the following categories: balance volatility, global spending, income normalized spending, categorical spending, saving, investing, non-sufficient funds/overdraft, income stability, and/or cash flow, and so on. Advantageously, under the transaction model, the system can monitor a consumer's portfolio in real time. The financial transaction model provides insight where traditional credit bureaus are blind. Again, the system can improve reliability even further by combining a transaction model with a credit model to generate a combination financial transaction-credit model.

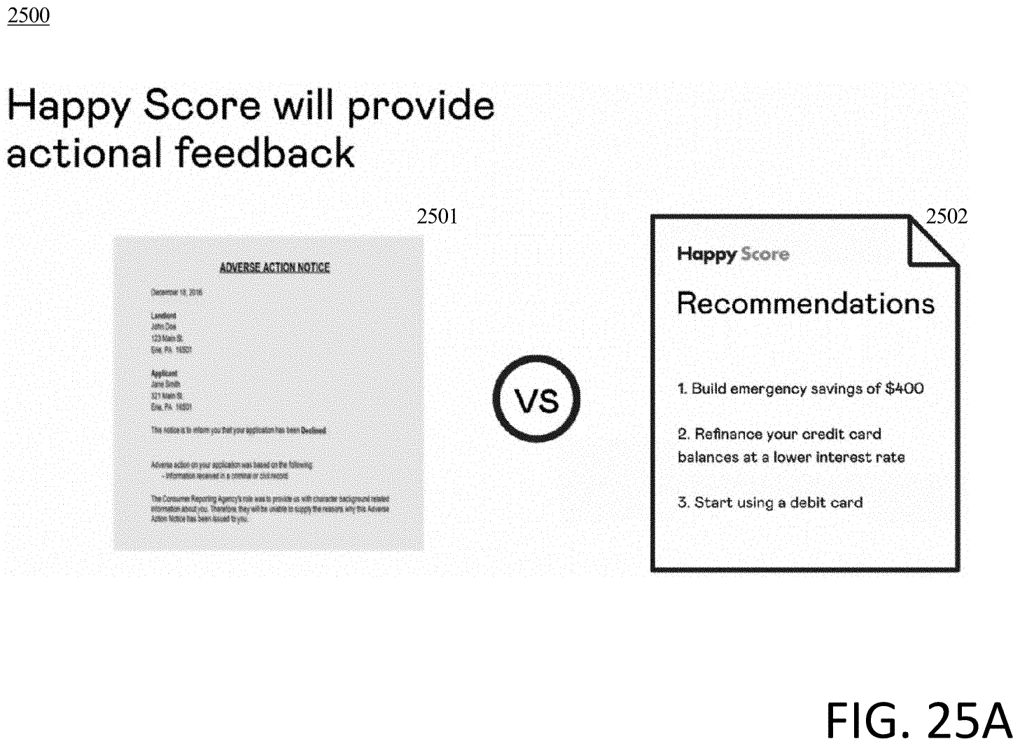

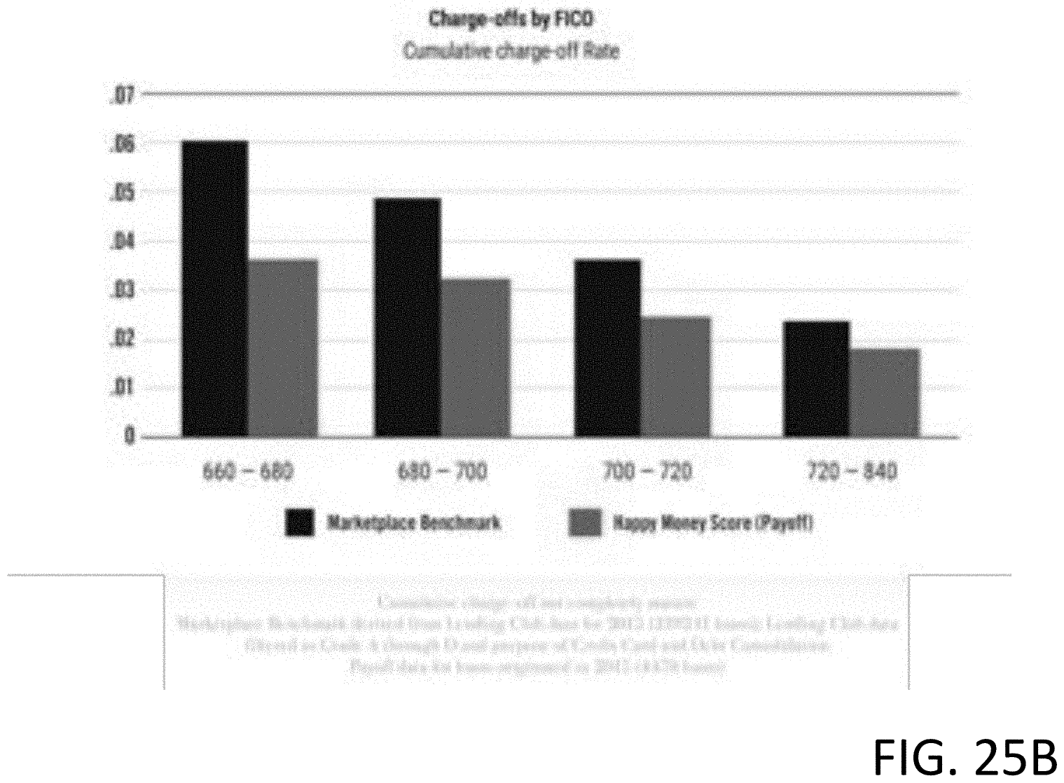

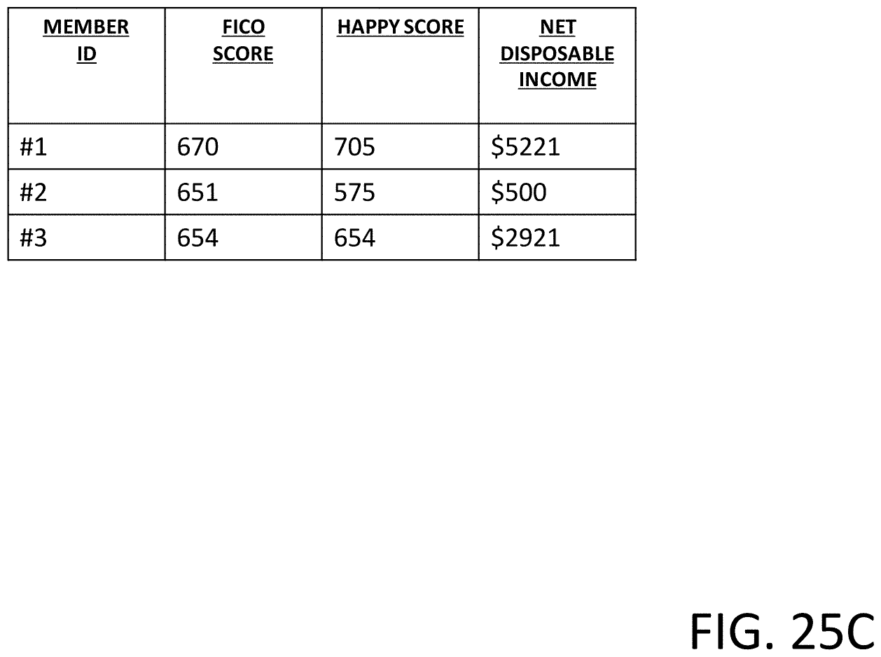

FIG. 25A illustrates an example comparison between credit bureau feedback 2501 and happy score recommendations 2502. Credit bureau feedback 2501 typically indicates what a consumer did, while happy score recommendations 2502 indicate what a consumer can do. Credit bureau feedback 2501 may be in the form of a letter that includes a credit score and a brief explanation of what the consumer did to receive an adverse action that affected their credit score. For example, the credit bureau may indicate some of the borrower's loans went into default. In contrast, happy score recommendations 2502 are proactive, more helpful, and more descriptive than credit bureau feedback 2501. The system may suggest, for example, building emergency savings of $400, refinancing credit card balances to a lower interest rate, and/or starting use of a debit card, among other things. Accordingly, happy score recommendations 2502 provide proactive advice for improving a consumer's happy score (e.g., cash transaction score or combination of transaction score and credit score). The system can provide happy score recommendations 2502 via letter on a user interface.

FIG. 25B illustrates chart comparing a happy money score translated to an equivalent scale of a FICO score versus charge off rates. Generally, with an equivalent happy money score, charge off rates are lower. Moreover, the happy money score is meaningful because it informs of the risks with more accuracy than FICO. Accordingly, a lender is more likely to make a loan using the happy money score. Referring now to FIG. 25C, the happy money score and the FICO score are moderately correlated. The happy money score is not systematically biased against the FICO score. However, the happy money score heavily relies on cash flow, whereas FICO is blind to cash flow. Consequently, consumers with high cash flows have higher Happy money scores relative to FICO and vice-versa.

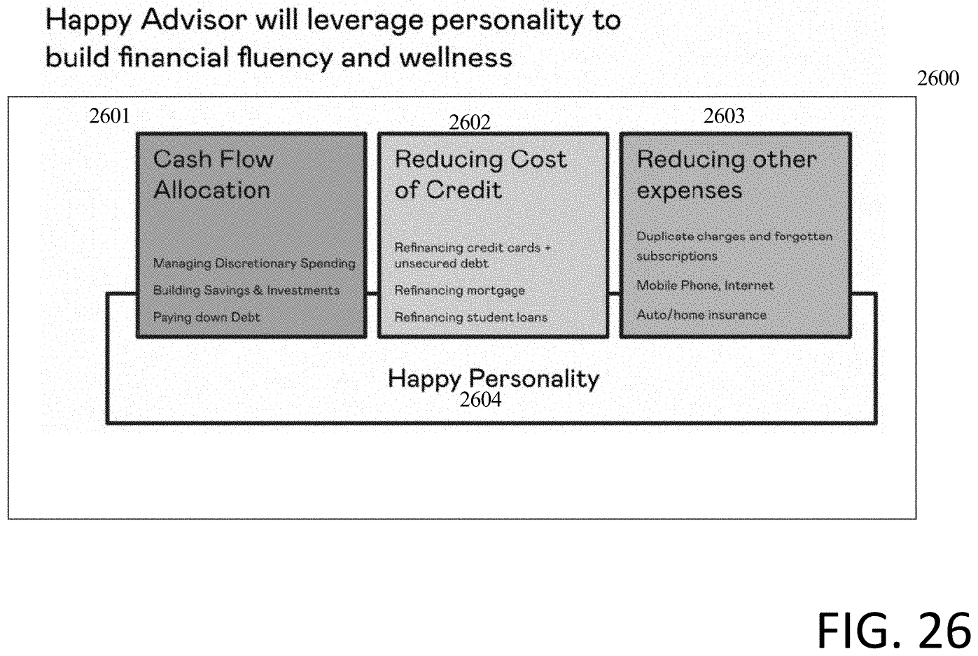

FIG. 26 is an example user interface of a chart 2600 illustrating proactive steps for a borrower based on a happy personality 2604. The system uses a borrower's happy personality 2604 to calculate a happy money score. A happy personality 2604 is a combination of a borrower's data associated with the predictors (e.g., checking account volatility, savings balance, etc.). Multiple borrowers can have the same happy money score while having different happy personalities 2604. For example, a first borrower may have a high checking account volatility with a high savings balance, while a second borrower may have a low checking account volatility with a low savings balance. Given the way the system calculates a happy money score, the two borrowers may end up having equivalent happy money scores, even though they have different happy personalities.

A happy personality 2604 enables a borrower to have a clearer picture of how they can reduce their default probability (e.g., reduce happy money score or transaction score) and thereby be a better candidate for loans. A happy personality 2604 provides user interfaces that display a borrower's cash flow allocation 2601, credit cost reduction 2602, and/or other expense reduction 2603, among other things. Cash flow allocation 2601 may include, for example, advice for managing discretionary spending, building savings and investments, and/or paying down debt, among other things. Credit cost reduction 2602 may include, for example, advice for refinancing credit cards, refinancing other unsecured debt, refinancing mortgages, and/or refinancing student loans, among other things. Other expense reduction 2603 may include, for example, advice for reducing duplicate charges and forgotten subscriptions, reducing mobile phone bills, reducing Internet service bills, and/or reducing auto/home insurance, among other things.

### CONCLUSION

There are number of advantages to the disclosed embodiments. When intent and business model are aligned on debt elimination, it's a win-win. The consumer's asset is a banks liability. This naturally opposing relationship puts banks in the asset production (otherwise known as debt pushing business) for their own balance sheets and to feed the unending appetite for a yield of global capital allocators through the debt capital market. The happy money score, based on transaction data of a borrower, is for the greater good to consolidate multiple high interest rate unsecured loans into one lower rate interest unsecured loan. The happy money score and the loan origination engine strives for a more altruistic view of an individual, and the happy money score enables that individual to take back control of their financial persona. The system and happy money score take a closer look at the borrower client with transactions data to avoid overlooking borrowers and can provide more loans as a result. Overall, the system enables a greater number of loans to be issued than a pure bureau score (e.g., FICO score) can.

There are several advantages to the lender clients of the system as well. Lender clients with lower interest rates (e.g., credit unions) on capital, that would not otherwise normally lend in an unsecured manner, are matched with borrowers evaluated in a better manner for risk by the happy money score generated from the underlying transactions data. The lenders are also clients of the loan origination system. With the loan origination system, lender clients avoid the overhead of marketing to consumers and the costs/overhead associated with originating loans. The lenders need only provide the underlying capital to support the system with a low interest rate loan. With the loan origination system, lenders can be more efficient with fewer office buildings to rent and offer more loans to more borrowers.

A computer, as well as a computer server, includes one or more processors and a storage device storing instructions executable by the one or more processors. When implemented in software, the elements of the embodiments are essentially the code segments (instructions) of a program executed by a processor to perform the necessary tasks. The program or code segments (instructions) can be stored in a processor readable storage medium (storage device). The processor readable storage medium may include any medium that can store information. Examples of the processor readable storage medium include an electronic circuit, a semiconductor memory device, a read only memory (ROM), a flash memory, an erasable programmable read only memory (EPROM), a magnetic media, a magnetic disk, a floppy disk, a magnetic hard disk, an optical media, an optical disk, a compact disk (CD), a digital versatile disk (DVD), or a Blu-Ray disk (BD). One or more of the code segments (instructions) of the software can be downloaded into a computer using computer data signals through computer networks such as the Internet, Intranet, etc. and temporarily stored in a storage device.

While certain exemplary embodiments have been described and shown in the accompanying drawings, it is to be understood that such embodiments are merely illustrative of and not restrictive, and that the embodiments are not be limited to the specific constructions and arrangements shown and described, since various other modifications may occur to those ordinarily skilled in the art. Furthermore, while this specification includes many specifics, these should not be construed as limitations on the scope of the disclosure or of what may be claimed, but rather as descriptions of features specific to particular implementations of the disclosure. Certain features that are described in this specification in the context of separate implementations may also be implemented in combination in a single implementation. Conversely, various features that are described in the context of a single implementation may also be implemented in multiple implementations, separately or in sub-combination. Moreover, although features may be described above as acting in certain combinations and even initially claimed as such, one or more features from a claimed combination may in some cases be excised from the combination, and the claimed combination may be directed to a sub-combination or variations of a sub-combination. Accordingly, the claimed embodiments are limited only by patented claims that follow below.

1. A client server system comprising:
a financial technical services computer server with one or more processors and a storage device storing instructions executable by the one or more processors to provide financial technical services;
one or more debtor client computers coupled in communication with the computer server, each debtor client computer having a processor with a storage device storing executable instructions, each debtor client computer executing the instructions to display a loan application to a debtor user to enter information for evaluation and communication of the loan application to the computer server, each debtor client computer further executing the instructions receiving account information; permission to access bank accounts, checking accounts, credit card accounts, and credit reports from credit bureaus; and communicating the account information and the permissions to the financial technical services computer server; and
a plurality of lender client computers coupled in communication with the financial technical services computer server, the plurality of lender client computers to provide interest rates for loan principal amounts and fund consolidating loans originated by the financial technical services computer server;
wherein the financial technical services computer server parses transaction data from the account information; determines a finance transactional score (FTS) based on the transaction data; matches a lender client with a debtor user and originates the consolidating loan in the case that the finance transaction score of the debtor user is within one or more score ranges, and
wherein the finance transactional score (FTS) is representative of the ability of the debtor user to pay interest and principal on the consolidating loan and expand the number of debtor users receiving consolidating loans.

2. The client server system of claim 1, further comprising:
at least one managing client computer coupled in communication with the financial technical services computer server, the least one managing client computer having a processor with a storage device for storing executable instructions, the managing client computer to oversee the financial technical services and provide agent review of the account information and loan application received from each debtor client computer.

3. The client server system of claim 1, wherein
at least one of the one or more first computers is a smart phone in wireless communication over a wide area network with the financial technical services computer server.

4. The client server system of claim 1, wherein
the financial technical services computer server provides failure advice to the debtor user in the case the consolidating loan is not originated by the financial technical services computer server.

5. The client server system of claim 1, wherein
the financial transaction score is a probability of default between zero and one.

6. The client server system of claim 5, wherein
One of the financial threshold ranges is between 0 and 0.374 for one loan rate;
One of the financial threshold ranges is between 0.375 and 0.400 for a second loan rate greater than the first loan rate;
One of the financial threshold ranges is between 0.400 and 0.425 for a third loan rate greater than the first loan rate; and
One of the financial threshold ranges is between 0.425 and 0.450 for a fourth loan rate greater than the first loan rate.

7. The client server system of claim 1, wherein
One of the debtor computers is a smart cellular telephone.

8. The client server system of claim 1, wherein
the financial transaction score is a credit score between zero and one thousand.

9. The client server system of claim 1, wherein
the financial transaction score is a credit score between three hundred and eight hundred fifty.

10. A method with a computer server, the computer server including one or more processors and executable instructions stored in a storage device, wherein the executable instructions are executed by the one or more processors, the method comprising:
receiving a loan application from a debtor with unsecured debt, the loan application including income, payments/expenses, assets, and liabilities/debt;
receiving financial transactions data associated with the debtor, the financial transactions data includes one or more bank/savings accounts, one or more income sources, one or more debts/liabilities, and one or more expense sources;
parsing the financial transactions data into predetermined data features;
verifying the income of the debtor on the loan application with the parsed financial transactions data, the income verification providing a measure of reliability of the input data in the loan application and one or more cutoff levels for loan origination processing;
ranking the parsed financial transactions data based on the predetermined data features; and
analyzing the parsed financial transactions data to determine a first probability of default by the debtor with a loan having a lower interest rate than an interest rate of the unsecured debt.

11. The method of claim 10, wherein
the unsecured debt is a plurality of credit card debt with a plurality of creditors.

12. The method of claim 10, further comprising:
transforming the first probability of default into a financial score based on the parsed financial transactions data and the verified income.

13. The method of claim 10, further comprising:
receiving credit bureau data from at least one credit bureau associated with the debtor, the credit bureau data comprising a credit report with trades lines data;
removing and discarding a FICO score from the credit report; and
analyzing the trade lines data of the credit report to determine a second probability of default by the debtor with the loan.

14. The method of claim 13, further comprising:
fusing and transforming the first and second probabilities of default into a financial score based on the parsed financial transactions data, the verified income, and the credit bureau report.

15. The method of claim 10, wherein
the verifying of the income of the debtor on the loan application includes
segmenting the debtor into one of a plurality of different risk levels based on a measure of income stability and applying one of a plurality of predetermined verification treatments of income based on the risk level into which the debtor is segmented.

16. A method of transactional score modeling, the method comprising:
receiving financial transactions data associated with a plurality of borrowers, wherein each of the plurality of borrowers is associated with one or more bank accounts;
calculating a financial metric for each borrower based on the financial transactions data;
dividing the plurality of borrowers into a plurality of groups based on the financial metric for each borrower, wherein each group is associated with a particular value of a financial metric;
calculating a charge-off rate for each group of borrowers based on a percentage of loan defaults among a population of borrowers in each group; and
displaying on a user interface financial metrics and charge-off rates associated with the plurality of groups.

17. The method of claim 16, wherein the calculating the financial metric for each borrower comprises:
running a transaction model on the financial transactions data to generate a transactions financial score (TFS).

18. The method of claim 17, wherein the running the transaction model comprises:
parsing the financial transactions data into one or more predetermined data features to generate parsed financial transactions data;
ranking the parsed financial transactions data based on the predetermined data features; and
analyzing the parsed financial transactions data to calculate the transactions financial score (TFS).

19. The method of claim 16, wherein the calculating the financial metric for each borrower comprises parsing the financial transactions data into one or more predetermined data features including one or more of:
volatility of checking account balance;
number of overdrafts;
savings balance;
number of income sources;
ratio of spending over income;
ratio of total cash balances over monthly loan payment;
stability of paycheck amount;
average overdraft amount; and
ratio of average credit card balance over average discretionary spending amount.

20. The method of claim 16, further comprising:
comparing charge-off rates for the plurality of groups to generate a comparison outcome;
discovering the comparison outcome includes charge-off rates that are within a statistically normal range; and
determining a transaction model associated with the financial transactions data is working properly based on the comparison outcome.

21. The method of claim 16, further comprising:
comparing charge-off rates for the plurality of groups to generate a comparison outcome;
discovering the comparison outcome includes one or more charge-off rates that are not within a statistically normal range; and
updating a transaction model associated with the financial transactions data based on the comparison outcome.

22-27. (canceled)
